(19) United States
(12) Patent Application Publication
(10) Pub. No.: US 2007/0080797 A1
(43) Pub. Date: Apr. 12, 2007

(54) Maintaining or identifying mote devices

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/245,492

(22) Filed: Oct. 6, 2005

(51) Int. Cl. G08B 23/00

(52) U.S. Cl. 340/500

(57) ABSTRACT

One aspect of the disclosure relates to identifying, at least partially using a maintaining device, at least one mote device to be maintained based at least in part on determining that the at least one mote device is not operating properly. Another aspect of the disclosure relates to determining, at least partially using a maintaining device, that the at least one mote device has been operating properly, and the mote device should undergo maintenance; and identifying, at least partially using the maintaining device, the at least one mote device to be maintained at least partially from the at least one mote device, based at least in part on the determining that the at least one mote device has been operating properly, and the at least one mote device should undergo maintenance.

### TECHNICAL FIELD

The following disclosure relates to mote devices, and maintaining the mote devices.

In certain aspects, a method can include, but is not limited to, identifying, at least partially using a maintaining device, at least one mote device to be maintained based at least in part on determining that the at least one mote device is not operating properly. In addition to the foregoing, other method aspects are described in the claims, drawings, and text forming a part of the present application.

In certain aspects, a method can include, but is not limited to, obtaining information, at least partially at a maintaining device, that at least one mote device has been operating properly and should be maintained; and identifying, at least partially using the maintaining device, the at least one mote device that should be maintained, based at least in part on the obtaining information that the at least one mote device has been operating properly and should be maintained. In addition to the foregoing, other method aspects are described in the claims, drawings, and text forming a part of the present application.

In certain aspects, a method can include, but is not limited to, maintaining, at least partially using a maintaining device, at least one mote device based at least in part on determining that the at least one mote device does not operate properly. In addition to the foregoing, other method aspects are described in the claims, drawings, and text forming a part of the present application.

In certain aspects, a method can include, but is not limited to, maintaining, at least partially using a maintaining device, at least one mote device based at least in part on determining that the at least one mote device operates properly, but should be maintained. In addition to the foregoing, other method aspects are described in the claims, drawings, and text forming a part of the present application.

In certain aspects, an apparatus can include, but is not limited to, a maintaining device to aid in determining, at least partially using a status indicator to determine, whether an at least one mote device should be maintained. In addition to the foregoing, other apparatus aspects are described in the claims, drawings, and text forming a part of the present application.

In certain aspects, an apparatus can include, but is not limited to, a maintaining device operable to identify at least one mote device to be maintained at least partially in response to the maintaining device obtaining information that the at least one mote device is not operating properly. In addition to the foregoing, other apparatus aspects are described in the claims, drawings, and text forming a part of the present application.

In certain aspects, an apparatus can include, but is not limited to, a maintaining device operable to obtain information describing that at least one mote device has been operating properly and should be maintained; and the maintaining device operable to identify the at least one mote device to maintain based at least in part on the maintaining device being operable to obtain the information. In addition to the foregoing, other apparatus aspects are described in the claims, drawings, and text forming a part of the present application.

In certain aspects, an apparatus can include, but is not limited to, maintaining means for identifying at least one mote device to maintain based at least in part on determining that the at least one mote device is not operating properly . In addition to the foregoing, other apparatus aspects are described in the claims, drawings, and text forming a part of the present application.

In certain aspects, an apparatus can include, but is not limited to, determining means for at least partially determining that at least one mote device has been operating properly; and the maintaining means for identifying the at least one mote device to maintain the at least one mote device based at least in part on the determining means determining that the at least one mote device has been operating properly. In addition to the foregoing, other apparatus aspects are described in the claims, drawings, and text forming a part of the present application.

In one or more various aspects, related apparatus and systems include but are not limited to circuitry and/or programming for effecting the herein-referenced method aspects; the circuitry and/or programming can be virtually any combination of hardware, software, electro-mechanical system, and/or firmware configured to effect the herein-referenced method aspects depending upon the design choices of the system designer.

In addition to the foregoing, various other method and/or system aspects are set forth and described in the text (e.g., claims and/or detailed description) and/or drawings of the present application.

The foregoing contains, by necessity, simplifications, generalizations and omissions of detail; consequently, those skilled in the art will appreciate that the foregoing is illustrative only and not intended to be in any way limiting. Other aspects, features, and advantages of the devices and/or processes and/or other subject matter described herein should become apparent in the text set forth herein.

### BRIEF DESCRIPTION OF THE FIGURES

FIG. 1 shows a block diagram of one embodiment of a mote network including at least one mote device;

FIG. 2 shows a block diagram of one embodiment of the mote device;

FIG. 3 shows a block diagram of another embodiment of the mote device;

FIG. 4 shows a view of one embodiment of the mote device;

FIG. 5 shows a view of another embodiment of the mote device;

FIG. 6 shows a view of yet another embodiment of the mote device;

FIG. 7 shows a front view of one embodiment of a maintaining device;

FIG. 8 shows a view of another embodiment of the maintaining device;

FIG. 9 shows a block diagram of one embodiment of the maintaining device;

FIG. 10 shows a block diagram of one embodiment of the maintaining device and mote device.

FIG. 11 shows a block diagram of one embodiment of the mote device;

FIG. 12, that includes FIGS. 12a, 12b, and 12c, is a flow diagram of one embodiment of a mote identifying/maintaining technique;

FIG. 13 shows a block diagram of another embodiment of the mote device;

FIG. 14, that includes FIGS. 14a, 14b, 14c, and 14d, is a flow diagram of another embodiment of the mote identifying/maintaining technique;

FIG. 15 is a flow diagram of an embodiment of the mote maintaining technique; and

FIG. 16 is a flow diagram of another embodiment of the mote maintaining technique.

### DETAILED DESCRIPTION

The present disclosure pertains in general to a variety of mote device aspects, and includes a number of formal outline headings for clarity of presentation. However, the outline headings are for presentation purposes, and different types of subject matter may be discussed throughout the disclosure (e.g., device(s)/structure(s) may be described under process(es)/operations heading(s) and/or process(es)/operations may be discussed under structure(s)/process(es) headings; and/or descriptions of single topics may span two or more topic headings, etc.). Hence, the use of the formal outline headings is intended to be illustrative in nature and not in any way limiting. Additionally, the numbering of the formal outline heading(s) is intended to improve readability of the disclosure, and is not intended to be limiting in scope.

I. Introduction to Mote Devices and Maintaining Devices

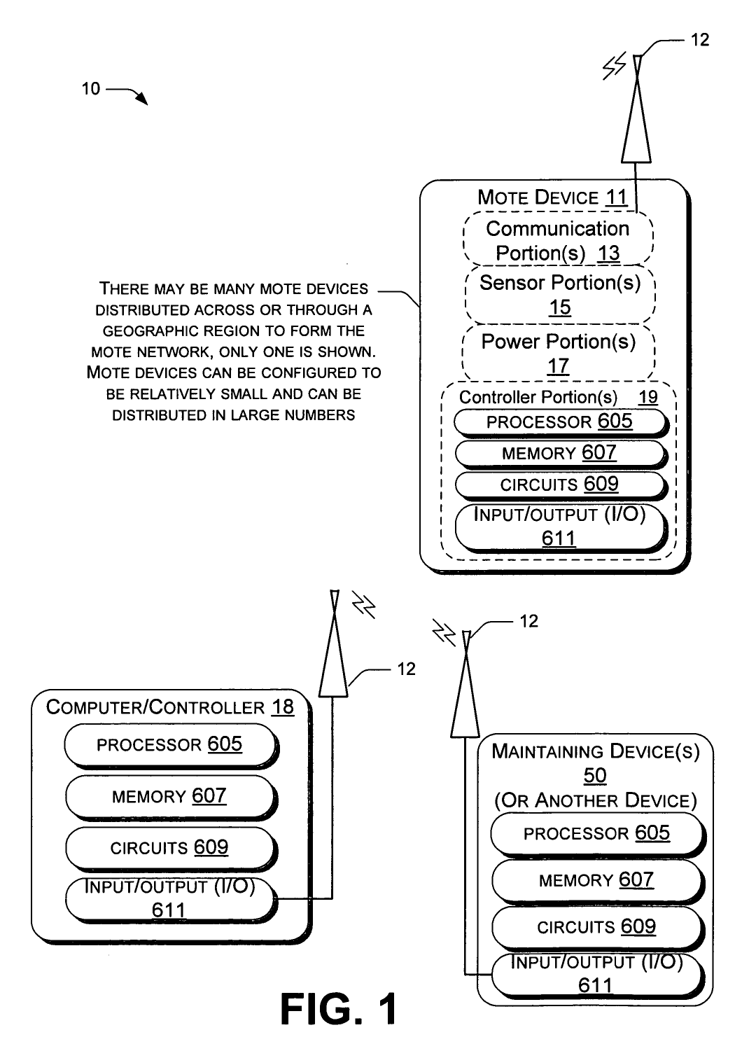

One embodiment of a mote network 10 that includes a number of mote devices 11 is described with respect to FIG. 1, in which the dimensions of the individual devices are not drawn to scale. In general, a mote device can be considered a small processor-driven device that can be configured to perform a variety of functions. Certain embodiments of mote devices, as described in this disclosure, for example, can sense a variety of parameters, actuate a variety of other devices such as (but not limited to) turn on or off a light emitting diode, and/or control a display in which the light elements (e.g., pixels) are controlled at least partially with at least one mote device. Certain embodiments of mote devices can be fabricated relatively small (typically less than several inches in dimension, often a fraction of an inch), can be relatively inexpensive to produce, and can be designed to stand up to relatively harsh and/or external environments. Many embodiments of mote devices can include a power source, which can be configured to provide power or energy to the mote during its normal operations.

As used in this disclosure, the term “mote device” typically indicates a semi-autonomous computing, communication, actuating, and/or sensing device as described in the mote literature (e.g., Intel Corporation's mote literature), as well as equivalents recognized by those having skill in the art (e.g., Intel Corporation's smart dust projects), similar to as illustrated with respect to FIG. 1. Many embodiments of mote devices, or simply “motes”, as described in this disclosure can provide a wide variety of parameter sensing and/or actuating functionalities. Such parameter sensing may be controlled (and/or light or display devices actuated) using computer-based, electromechanical, magnetic, or other techniques. Certain mote devices can be located at a remote, hostile, external, or inaccessible location, which can make access to the mote devices for such purposes as maintenance, repair, or replacement difficult, expensive, hazardous and/or even virtually impossible. In one embodiment, repair of mote devices in a mote network can be color coded. For example, those motes having insufficient power can be color coded (or color coded status indicators such as tags, as described in this disclosure) with a first color. Those mote devices that are failing operationally can be color coded (or have their status indicators color coded) with a second color. As such, a number of maintaining devices or maintaining persons may be associated with the same mote network, each maintaining device or maintaining person can perform one or more maintaining operations including, but not limited to, collecting, repairing, discarding, reconfiguring, etc. of the mote devices within that mote network. Additionally, mote devices can be installed within, or distributed across a variety of different environments that could have varying characteristics including, but not limited to: across the field, within a structure such as a building, bridge, highway, or dam, underwater, within a vehicle (e.g., to sense an engine parameter or operate a vehicle actuator), etc.

In this disclosure, a variety of techniques can be provided to allow mote devices to achieve some type of “goal” as a functioning device within the mote network. Examples of such a goal can include, for example, maintaining power, performance, and/or reliability in individual mote devices and/or their batteries across a mote network, ensuring that a particular percentage of mote devices do not fail, maintaining a certain reliability of the mote devices across a mote network, etc. can thereby represent a goal. Providing certain goals or tasks can represent a considerable challenge and/or expense.

An example of a specific goal may be to have some mote devices operate during some prescribed time period with less than some prescribed percentage of the mote devices within the particular mote network failing. Additionally, balancing data stored in the various mote devices across a mote network in a desired fashion (e.g., such that all data can be readily and reliably accessed) can represent another goal for the mote devices within the mote network. Also, ensuring that each mote device (or certain percentage of mote devices) is operating properly or providing proper output can represent another mote device goal in the mote network. These examples of goals of mote devices within mote networks are intended to be illustrative in nature, while not limiting in scope. Since it is envisioned that certain mote networks can be configured with the sizable array of mote devices, maintenance of mote devices can represent a very real challenge for certain mote networks. This disclosure can therefore provide a number of mechanisms by which power levels, energy levels, data storage, and/or operational characteristics within various ones of the mote devices across a mote network can be effectively and efficiently maintained. In different embodiments, the ability of the mote device to meet any mote device goal or mote network goal could be determined (e.g., computed) by the maintaining device, individually by the motes, and/or by a distinct computer/controller device monitoring the mote network.

Another embodiment of goal for a mote device with respect to the mote device network may be to have a prescribed percentage of mote devices operable reliably within a mote network for some prescribed duration (e.g., a month). As such, a mote device should be able to ascertain how many mote devices within its network are operating reliably. Another goal may be to ensure that all important data for the mote network is stored in at least one mote device and/or a computer/controller associated with the mote network.

While many mote device applications pertain to sensing one or more parameters, it is also envisioned that mote devices can activate a variety of actuators. For example, in one embodiment, one or more mote devices can be configured to control an electric current that could be applied to an actuator. As such, another mote device goal with respect to mote networks can include ensuring that those mote devices that can perform actuating operations can perform these operations effectively and/or efficiently.

Power and/or energy can represent a considerable design consideration for mote devices that would be useful to maintain and/or control. This disclosure provides a variety of techniques and mechanisms by which power/energy levels of at least certain ones of the mote devices can be monitored, determined, and/or enhanced. For example, certain mote devices require a prescribed power/energy level to perform a particular sensing operation(s), and/or other operation(s). As such, it is important to consider whether one or more mote device(s) across a particular mote network have sufficient power/energy levels to perform the particular operation(s). If an energy level or other condition of the mote device(s) varies from a prescribed level, it may be desired in certain embodiments to maintain the mote device and/or identify those mote devices to be maintained. Different embodiments of the maintaining the mote device(s) can include, but are not limited to: repairing the mote device(s), collecting the mote device(s), transporting the mote device(s) to a remote location, reconfiguring the mote device(s) within a mote network, charging a power supply or battery of the rechargeable mote device(s), destroying the mote device(s), attending to mote device(s) to be maintained, transferring the mote device(s) to a different mote network, and/or repositioning the mote device(s) within the mote network so that they still perform their desired functions and/or operations. As such, within this disclosure, the term “maintaining” a mote device can relate to any of these or similar operations pertaining to a mote device as would be understood by one skilled in the art.

This disclosure can also describe a number of maintaining devices 50, as described with respect to FIG. 1. Within this disclosure, the term “maintaining device” represents those devices that can actually maintain, or assist in maintaining, those mote device(s) that are to be maintained. Certain embodiments of maintaining devices can, for example, travel to where those mote device that are to be maintained are located; and actually collect the mote devices to be returned to some location after which they can be repaired, returned to service in the same or a different mote network, etc. Other embodiments of maintaining devices, for example, travel to where the mote devices that are to be repaired are recharged are located, and repair or recharge the mote devices at that location. Other embodiments of maintaining devices identify to a person where the mote devices to be maintained, repaired, collected, addressed, reconfigured, recharged, etc. are located, and allow the person to pick up the mote device to perform a suitable operation. For instance, certain maintaining devices can flip over mote devices to yield a surface portion of the mote that has different colors, appearances, reflectivity, etc. at different portions of the mote device to allow those mote devices to be identified to be maintained by a person, or another machine or device, and thereby perhaps more easily and effectively locate and/or maintain the mote devices to be maintained. As such, maintaining devices can be configured in a variety of embodiments to perform a variety of operations relating to maintaining mote devices, identifying, and/or locating mote devices to be maintained.

This disclosure also provides a variety of techniques and mechanisms by which mote devices can be maintained (e.g., by a maintaining device, a person, or a distinct entity), that can include but not limited to: charging the mote device to increase the power of the mote device (or the mote device's battery); monitoring the energy of the mote device for when it drops below a prescribed level; correcting undesired data conditions of the mote device(s); and/or collecting data from particular mote devices; etc. These techniques and mechanisms as described in this disclosure are illustrative in nature, and are not intended to be limiting in scope. For example, when a power level of a particular mote device drops below a prescribed limit, it may be desired to maintain that particular mote device, and replace or recharge its power source (e.g., a rechargeable battery).

There may be other reasons to maintain a mote device from the mote device failing, or otherwise acting improperly. It may be desired to maintain certain embodiments of mote devices such as by collecting data directly from a mote device (or recharging the mote device) even if the mote device has been operating properly. Status indicators which are attached to mote devices or otherwise associated with a mote device can change to indicate, in some manner, that the mote device should be maintained. For example, one embodiment of mote devices can change color to identify those mote devices to be maintained. As such, certain types of status indicators can be applied to mote devices in a manner that allows maintaining devices to more readily determine the position of the mote devices to be maintained. Certain embodiments of goals for a mote device within the mote network may relate to downloading data to a maintaining device and/or other device on a periodic or other basis. For example, a particular mote device may contain data either relating to parameters that the mote device has sensed, or alternatively that another mote device has sensed. It may thereby be desired to achieve the mote device(s) “goal” by transferring the sensed data to another device that can process the data, such as a data processing device or a computing device (e.g., a personal computer, a laptop, a microprocessor, a microcomputer, etc.) to thereby balance or otherwise distribute data within a mote network.

This disclosure also provides a number of techniques and status indicator mechanisms by which mote devices can indicate to maintaining devices, other devices, or a person that the mote device should be maintained. For example, in certain embodiments, a surface portion of the mote device can change color in a manner that can be detected by a maintaining device or a person who is acting to maintain the mote network. In other embodiments, the mote device can transmit light having a particular characteristic in a manner that can be detected by the maintaining device or a maintaining person. In still another embodiment, the mote device can transmit a radio signal that can be detected by the maintaining device or a person. In certain embodiments, the mote device can also change reflectivity to reflect a change in status. In certain embodiments, the mote device can be physically flipped over to expose a surface having a different color, appearance, reflectivity, light-admitting characteristic, etc. if the mote devices are to be maintained, and thereby flipping these mote devices can act as a status indicator. In yet another embodiment, the mote device(s) to be maintained can output an acoustic signal and/or vibrate in a manner that can be identified to be maintained by the maintaining device and/or maintaining individual. As such, status indicators can indicate one or more states for a mote device.

Certain embodiments of the status indicator can also include changing a shape, a position, or a conformability of the mote device. For example, the shape of certain embodiments can be changed from substantially flat to oval or round (for example, by filling chambers in the mote device with a fluid or liquid). An oval or round mote device may be easier to locate on a surface such as a roadbed or field than a similarly colored flat device.

Other embodiments of status indicators may operate by changing the position of a mote device. For example, certain embodiments of mote devices may “jackknife” between a closed-hidden position and an open easily-detected position. In another embodiment, a flag or detector segment may extend to make the mote device more easily detectable.

Yet other embodiments of mote devices may be configured to adjust their conformability to be more easily detected or identified. For example, certain mote devices can be altered between a relatively non-conformable position that is relatively difficult to grab, and a relatively conformable extended position that is more easily grabbed by a person or the maintaining device. As such, ease of conformability for certain embodiments of mote devices may increase the ability of the maintaining device to “grab” the mote device.

As such, certain embodiments of status indicators can be configured to operate by changing a shape, changing a position, and/or changing a conformation of the mote device to make the mote device easily detected or identified by the maintaining device, and/or allowing the mote device to be more easily “grabbed” by the maintaining device. Therefore, status indicators can be configured as: a) anything that can draw attention to the mote device; b) anything that identifies the mote device; and/or c) anything that communicates a relevant state from a mote device.

As such, one aspect of the present disclosure is to provide mote device(s) that possess some status indicator, the status indicator can change some characteristic that can be identified by a maintaining device, or other device, such that those mote devices that should be maintained can be maintained more easily and effectively than without the mote device changing its characteristics. It is envisioned that the characteristics of the status indicator for the mote device that may change can include, but are not limited to, appearance, color, light-admitting characteristics, vibration characteristics, acoustic characteristics, etc. The mote devices to be maintained thereby can interact with certain embodiments of maintaining devices (or individuals) to identify themselves to the maintaining devices as mote devices that should be maintained.

Each mote device can be configured to provide one or more of a variety of functions. This disclosure thereby provides various embodiments by which power in an individual mote device can be enhanced as the power drops below a prescribed level. For example, within a mote network, a variety of signals, communications, etc. can be provided between one or more mote devices and/or other devices to transfer sensed data, or mote device power information, between the mote devices that could be positioned at various locations. Such signals, communications, etc. contain considerable energy. This disclosure provides a number of techniques by which the energy contained within the signals, communications, etc. can be converted into a form that can be utilized to power the mote device, and thereby possibly extend the useful lifetimes and/or operational reliability of the mote device(s) within their respective mote networks.

By ensuring that those mote devices within the mote networks that are not operating properly or not configured properly are replaced, repaired, and/or removed; the user of certain mote networks can be assured of a more reliable operation of the mote network in general.

II. Examples of Mote Devices and/or Technique(s)

As described in this disclosure, the mote device(s) 11 as described with respect to FIG. 1 may be considered, by their normal operations, as achieving their individual goal(s). When certain one(s) of the mote devices cannot operate properly, such as by running out of power or energy, or storing too much or too little data, those mote devices may not be able to achieve their goal with respect to the mote network. In certain embodiments, those mote devices should thereby either be identified to be maintained, identified within the mote network as operating insufficiently, and/or maintained. It is envisioned that certain mote devices 11 within the mote network 10 can transmit data to the mote devices, as well as perhaps other non-mote devices. Many embodiments of the mote devices 11 can utilize wireless communications (e.g., in certain embodiments of radio frequencies). A variety of wireless communication techniques can be utilized in a variety of networking devices, including but not limited to mote devices. In general, mote devices 11 can be configured to sense a variety of parameters such as, but not limited to, temperature, pressure, certain electrical/magnetic characteristics, position, velocity, inertia, presence or absence of individual persons or vehicles, moisture, etc. Such data or information can relate to sensed parameters which can be transmitted (utilizing wireless communication techniques), between one or more mote devices 11 and/or one or more computers/controllers 18 as described with respect to FIG. 1.

Each mote device may be configured to perform a variety of controller and/or communication operations utilizing computer and/or networking techniques as described herein. One embodiment of the mote devices 11, as configured with respect to FIG. 1, can include a communication portion 13, a sensor portion 15, a power portion 17, and a controller portion 19. In certain embodiments, the communication portion 13 can be configured to provide communication of signals and/or transfer of sensed data with other mote devices 11, the maintaining device 50, and/or the computer/controller 18. In one embodiment, the communication portion 13 can include an antenna 12 (certain embodiments of the antenna may transmit/receive electromagnetic radiation at radio frequencies, optical frequencies, infrared frequencies, etc. to provide a wireless link between mote devices, computer/controllers 18, etc.) that can provide a transfer of such signals and/or information to other mote devices 11, the maintaining device 50, and/or the computer/controller 18. In certain embodiments, a user interface that can control one or more operation(s) of the computer/controller 18 can be physically separated from the computer/controller. In these embodiments, the user interface can be operationally connected to the computer/controller 18 using wireless, wired-based, and/or other networking data-transfer techniques.

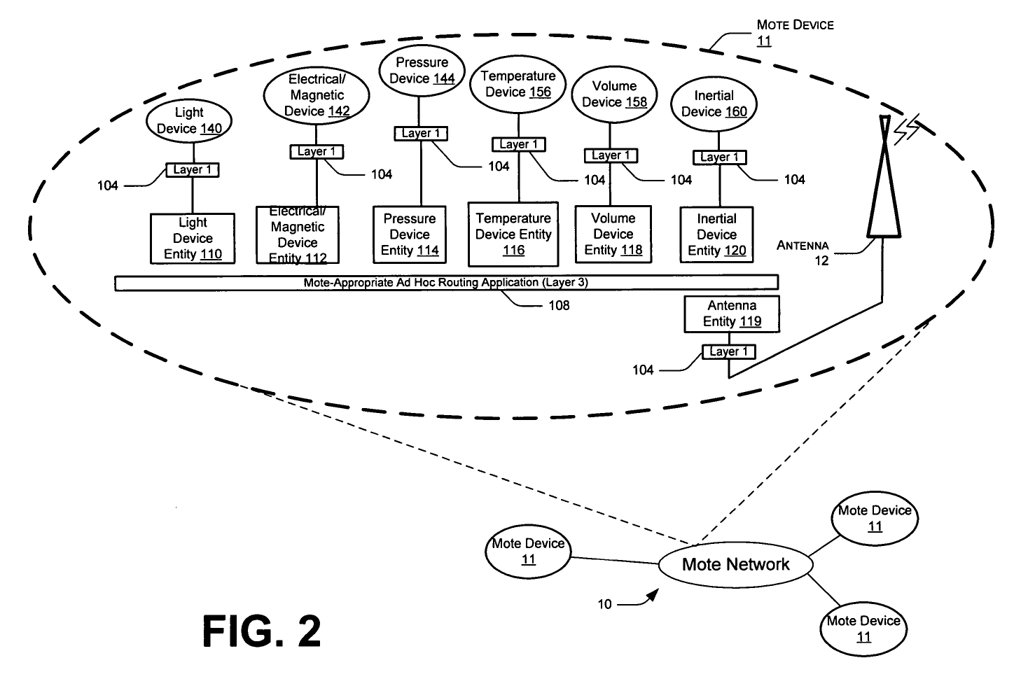

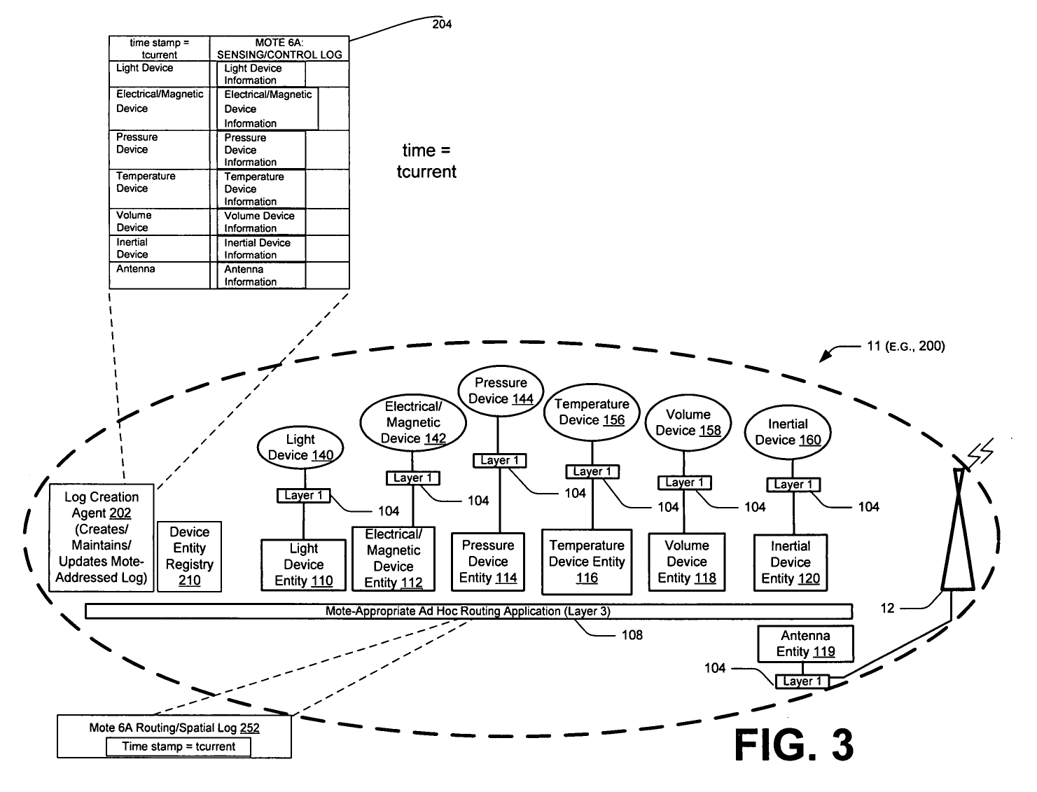

Certain embodiments of sensor portion 15 are configured to sense one or more parameters to be sensed by the mote device 11. A variety of such parameters that can be sensed are described with respect to the various devices 140, 142, 144, 156, 158, and/or 160, as described with respect to FIGS. 2 and 3. Those parameters to be sensed, as well as the devices to sense the parameters, are intended to be illustrative in nature, and not limiting in scope. It is envisioned that the rate at which each of these individual parameters are sensed may depend upon the particular configuration of the mote device 11 that can include, but is not limited to: sensed parameters for the mote device, user input to the mote device, etc. In certain embodiments, the mote sensing rate of any or each of the sensed parameters can be controlled and/or determined by the computer/controller 18.

Certain embodiments of the controller portion(s) 19 that are located within each one of certain embodiments of the mote device 11 can include, but are not limited to: a processor 605, a memory 607, a circuit 609, and an input/output (I/O) 611. The controller portion 19, as well as its component, can rely on computing architecture and technologies, such as utilized by a microprocessor or microchip. FIG. 1 also illustrates two other devices (the computer/controller 18 and the maintaining device 50) that include similarly referenced components: 605, 607, 609, and 611. The devices 11, 18, and 50 are each provided with similar component reference characters 605, 607, 609, and 611 that pertain to computer/controller components that are included in each of the devices 11, 18, or 50, and can rely on similar computer architecture to provide their computer and/or controller technology. For example, each device 11, 18, and 50 can rely on any combination of hardware, software, and/or firmware as is generally understood by those of ordinary skill in the computer and/or controller technologies. As such, certain mote sensing and/or operation processes can be performed by any one of, or any combination of, the devices 11, 18, and/or 50.

Many embodiments of the mote device 11 can be configured to be quite small (e.g., in many embodiments less than several inches, or even less than an inch), and thereby mote devices can be distributed in relatively large numbers within an area to be sensed. As such, the mote devices can be configured to perform their sensing or operation functionality relatively unobtrusively. Additionally, many embodiments of mote devices can be configured to be powered by a relatively low-power device, such as those that may utilize a double-A battery or a power cell. For many of the reasons described in this disclosure, maintaining a longevity of operation for the power source can become an important consideration for many embodiments of this disclosure.

Providing power to many types of mote devices in a manner that can ensure a relatively long and reliable operation of certain embodiments of a mote device can be challenging, especially considering many applications of mote devices. Many mote devices can be positioned in a variety of dangerous and/or difficult to reach or maintain locations. As such, it may be difficult to maintain power/energy to such mote devices, or alternatively service such mote devices such as by ensuring that they are operating properly, are properly configured, and are therefore capable of sensing a variety of parameters or performing a variety of operations. Certain embodiments of the mote devices can be located at various difficult to reach locations such as, but not limited to: an operating automobile or aircraft; within a building, dam, roadway, or a nuclear power plant; at various locations in the human body such as may be desired to access during surgery; underseas at a variety of locations; deep in a forest; or high on a mountain, etc. As such, many embodiments of mote devices can, in general, sense a variety of parameters at a variety of locations, and some of the locations may be remote and/or hostile for individuals to access, repair, and/or provide power and/or energy. Due to the relatively low cost of a variety of certain embodiments of the mote devices as compared to other larger and operationally complex sensor and/or actuator devices, it is envisioned that the mote devices can be distributed in relatively large numbers to provide a gradient of sensed parameters or provide a variety of operations, or alternatively across a larger area. It is envisioned that as the use of mote devices and their associated networks becomes more commonplace, the number of mote devices within certain mote networks will become so large that maintaining the mote devices could provide a challenge. As such, in many embodiments, it may be preferred to “automate” many operations associated with the maintenance of mote devices within the mote networks, such as, but not limited to, mote device maintenance, and/or identification of mote devices to be maintained. Many of the applications for mote devices can demand a relatively high degree of reliability from the power portion and/or it can be exceedingly difficult to replace the power portion thereto.

Certain embodiments of the power portion 17, (depending upon their intended use and design), can be configured to provide power to the mote device 11, as well as the communication portion and sensor portions contained therein. In different embodiments, the power portion 17 can be configured as a battery (chargeable and/or disposable), a power supply, and/or a power reception device that can receive power from outside of the mote device. In certain embodiments, the power reception device can convert the power received. For example, a solar panel can be attached to the mote devices 11, and the energy received from the solar panel can be converted and used to power the mote device. In an alternate embodiment, energy contained in a received signal can be converted into a frequency and/or a form such that the energy of the signal can be utilized by the mote device(s) 11 to power the mote device(s). These and other operational configurations of the communication portion 13, the sensor portion 15, and the power portion 17, are provided as illustrated within this disclosure, and are not intended to be limiting in scope.

The computer/controller 18 can be configured as a variety of computers and/or controllers to control at least some sensing operations of the mote devices 11 (and/or the other devices 18 or 50, as described with respect to FIG. 1), and/or receive, store, or otherwise process at least some sensed output parameters from the mote devices 11 and/or the other devices 18 or 50. In different embodiments, the computer/controller 18 can be configured as a standalone computer, a laptop computer, a desktop computer, a microprocessor, a microcomputer, a mainframe computer, and/or any other type of computer that can process data or other information relating to sensed parameters such as provided by the mote devices 11 and/or the other devices 18 or 50. The configuration of the computer/controller 18, as described with respect to FIG. 1, is intended to be illustrative in nature and not limiting in scope; more detail relating to the devices 11, 18, and/or 50 are provided in this disclosure.

The positioning of the mote devices 11 can be determined by the user, owner, other person, machine, computer, etc. depending upon the particular parameters that are desired to be sensed. In certain embodiments, after the mote devices 11 have been positioned, the location of certain techniques can be determined, and the position utilized to provide communications between the particular mote devices. In certain embodiments, for example, mote devices 11 can be distributed within a building, house, or other structure to determine particular sensed parameters with respect to that structure. In certain embodiments, it may be desired to locate other devices 18 or 50 that are associated with the mote device(s) 11 and in operational proximity to the mote device(s) 11 (as described with respect to FIG. 1).

In other embodiments, for example, mote devices 11 can be distributed in a variety of configurations including, but not limited to: along roadways or walkways to, in certain cases, determine sensed parameters relating to vehicles or persons travelling thereupon, etc. For example, mote devices 11 could be laid upon the ground, a floor, a walkway, etc.; integrated into structures that are laid upon the ground, a floor, a road, a walkway, etc.; or physically embedded within the ground, a floor, a road, or a walkway, etc. In other embodiments, for example, mote devices 11 can be distributed across a field, a crop area, in the ground, in a garden, around a family's yard, around a secured business area, within a forest, etc. to sense parameters or perform some functionality with respect to each particular area. Mote devices can, in certain embodiments, therefore be utilized to sense a variety of parameters and/or perform a variety of operations as described within this disclosure.

Certain embodiments of this disclosure relate to the use of one or more of the maintaining devices 50, as described with respect to FIG. 1. The maintaining device 50 can be used to determine those mote devices that should be maintained, as well as in certain embodiments physically maintain one or more mote devices 11. In other embodiments, the maintaining device can determine those mote devices to maintain, and indicate a position of the mote device for another device and/or a user to maintain.

Certain mote devices may be desired to be maintained for a variety of purposes that are intended to be illustrative, but not limiting. The variety of reasons for maintaining the mote devices can include, but are not limited to: increasing mote device(s) power or battery power, repairing damage to the mote device(s), retrieving certain sensed data or sensed information from the mote device(s), updating sensing operations of the mote device(s), updating other operations of the mote device(s), repositioning of the mote device(s), reconfiguring the mote device(s), and/or repositioning the mote device(s) within an existing mote network, etc.

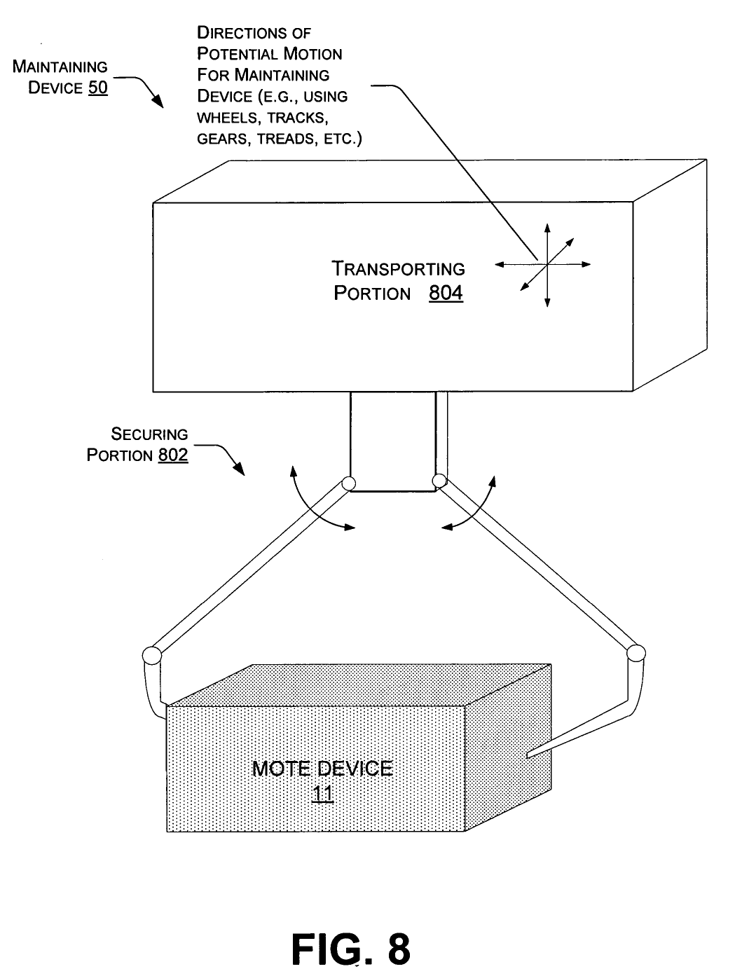

A variety of techniques are described in this disclosure, in which one or more of the maintaining devices 50 can maintain mote devices, and certain such techniques are described with respect to FIGS. 7 and 8. One embodiment of a maintaining device, as described with respect to FIG. 8, is largely automated, and can determine a location of one or more mote devices that can be used to effectively “pick up” each desired one of the mote devices. Another embodiment of the maintaining device, as described with respect to FIG. 7, can indicate a location (e.g., providing a course to the mote device, as well as a distance) of the mote devices to a user, and a human or mechanic “user” can thereupon pick up the mote device (either the user picks up the mote devices by themselves, or the maintaining device can be utilized by the user to pick up the mote device). Any device that either mechanically, manually, or automatically maintains (e.g., obtains, collects and/or attends to, etc.) one or more mote devices in any way; or alternatively assists a user (human or mechanical) to physically maintain one or more mote devices in any way can be considered one of the maintaining devices 50 as described within this disclosure.

In certain embodiments, the mote devices 11 can perform some action, process, etc. to assist the maintaining devices 50 in maintaining the mote devices. For example, in certain embodiments, the mote devices can change color, texture, emit a sound, provide positional information of the mote device that can be understood by the maintaining device, etc. in a manner that can be recognized by the user, the computer/controller 18, and/or the maintaining/identifying devices 50 that could ease maintaining the mote device. In other embodiments, the mote device can vibrate and/or emit an acoustic signal that can be detected by the maintaining device to allow the maintaining device to identify the mote devices to be maintained and/or attended to. In other embodiments, the mote device 11 can transmit a maintaining signal (e.g., over its antenna 12) that is of some frequency, and can be transmitted over some media such as air, that can be received by the maintaining device 50 and/or the computer/controller 18. Such signals contains information which indicates to the maintaining device 50 (or a user thereof) that the mote device 11 is ready to be maintained, collected, and/or in any way attended to.

In certain embodiments, the maintaining device 50 can maintain, collect, and/or attend to one or more of those mote devices 11 that are not operating as desired. For example, those maintaining devices that are configured to maintain and/or attend to those embodiments of mote devices that may be below some desired parameter limit (such as power) can be configured to allow the mote device to sense a particular parameter and/or perform a suitable operation. Resulting from reduced device power or battery power, certain mote devices may be incapable of transmitting and/or receiving data. It may be desirable to utilize one or more mechanism(s) to the maintaining device(s), as described in this disclosure, to allow the maintaining device(s) to maintain one or more mote devices. These embodiments of maintaining devices provide for maintaining those motes that are not operating as desired.

Certain embodiments of maintaining devices can be configured to maintain those mote devices that have been operating as desired for some prescribed duration, but may require maintenance, data transfer, etc. as a result of the operation. This can rely on the premise that for maintenance of particular mote devices within a mote network, each mote device should be checked after some duration, regardless of how well the mote device is operating, to ensure that the mote devices continue to perform adequately across the mote network, and thereby continue to meet their operational goals with respect to the mote network.

For example, it might be reasonably expected for certain motes located at a particular location, and configured to sense one or more particular parameters, to have obtained sufficient data after a particular period of time, such that sufficient data may be located at the mote device to justify maintaining, collecting, or attending to that mote device. For example, assume that the amount of data that has or could have been maintained by a particular mote device has reached some prescribed limit. It might be desired to download the data such that it could be saved in another location (and in certain embodiments the data can be discarded) as desired for the particular application and/or situation, to allow for the mote device to operate as desired without an access of data. Also, it may be desired to analyze the data after sufficient data has been maintained. As such, this disclosure provides a number of mechanisms that allow maintaining devices to maintain mote devices, such that their data can be maintained. After the mote devices have been maintained, collected, and/or attended to, in different embodiments, the mote devices can be maintained, returned, collected, discarded, repositioned at the same or different location to continue to operate as desired, reprogrammed for a different sensing purpose or operation, not utilized, attended to, etc. Following these re-alignments and/or reconfigurations of the mote devices within the mote network as provided during the maintenance, hopefully the mote devices that are returned to service can be expected to interact with the remaining mote devices within the mote network to perform the intended operations of at least certain collective mote devices within the mote networks, and thereby achieve the goals of the collective mote devices within the mote network. As such, as described above, the term “maintaining” a mote device should be applied to a number of operations (that can be performed by a maintaining device or person) such as collecting, repositioning, reconfiguring, attending to, etc. following the locating of the mote device.

FIGS. 2 and 3 illustrate two embodiments of a mote device. FIG. 2, shows an example of the mote device 11 of the mote- network 10 that may serve as a context for introducing one or more processes and/or devices described herein. Mote devices, in general, can be configured to include sensors, actuators, computational entities, and/or communications entities. The mote device 11, as described with respect to FIG. 1, can represent a specific example of a more general mote. The embodiment of the mote device 11 of FIGS. 2 and/or 3 is illustrated as including the antenna 12, physical layer 104, antenna entity 119, network layer 108 (shown for sake of example as a mote-appropriate ad hoc routing application), light device entity 110, electrical/magnetic device entity 112, pressure device entity 114, temperature device entity 116, volume device entity 118, and inertial device entity 120. The particular entities 110, 112, 114, 116, 118, and 120, as well as the other components in these figures, are intended to be illustrative in nature and not limiting in scope. Those entities that are selected can determine those parameters that the mote device can sense, as well as those operations that the mote devices can perform. Additionally, the mote devices 11 can be configured to provide a variety of operations and/or functions.

Many embodiments of the physical layer 104, as provided within the mote device 11, can provide for data transfer to/from a number of devices (140, 142, 144, 156, 158, and/or 160, etc. as described with respect to FIGS. 2 and/or 3) that allow for sensing a variety of parameters or providing a variety of actuation. Each one of the respective light device entity 110, electrical/magnetic device entity 112, pressure device entity 114, temperature device entity 116, volume device entity 118, antenna entity 119, and inertial device entity 120, as depicted, can couple through physical layers 104 using the respective light device 140, electrical/magnetic device 142, pressure device 144, temperature device 156, volume device 158, antenna 12, and inertial device 160. Those skilled in the art will appreciate that the herein described entities and/or devices are illustrative, and that other entities and/or devices consistent with the teachings herein may be substituted and/or added.

Those skilled in the art will appreciate that herein the term “device,” as used for data transmitting applications in the context of the “mote device”, or “mote”, is intended to represent but is not limited to transmitting devices and/or receiving devices dependent on context. In some exemplary lighting contexts, the light device 140 can be implemented using one or more light transmitters (e.g., coherent light transmission devices or non-coherent light transmission devices) and/or one or more light receivers (e.g., coherent light reception devices or non-coherent light reception devices) and/or one or more supporting devices (e.g., optical filters, hardware, firmware, and/or software). As such, the light device 140 can perform a variety of light operations, upon actuation. In some exemplary implementations, the electrical/magnetic device 142 can be implemented using one or more electrical/magnetic transmitters (e.g., electrical/magnetic transmission devices) and/or one or more electrical/magnetic receivers (e.g., electrical/magnetic reception devices) and/or one or more supporting devices (e.g., electrical/magnetic filters, supporting hardware, firmware, and/or software). In some exemplary implementations, the pressure device 144 can be implemented using one or more pressure transmitters (e.g., pressure transmission devices) and/or one or more pressure receivers (e.g., pressure reception devices) and/or one or more supporting devices (e.g., supporting hardware, firmware, and/or software). In some exemplary implementations, the temperature device 156 can be implemented using one or more temperature transmitters (e.g., temperature transmission devices) and/or one or more temperature receivers (e.g., temperature reception devices) and/or one or more supporting devices (e.g., supporting hardware, firmware, and/or software). In some exemplary implementations, the volume device 158 can be implemented using one or more volume transmitters (e.g., gas/liquid transmission devices) and/or one or more volume receivers (e.g., gas/liquid reception devices) and/or one or more supporting devices (e.g., supporting hardware, firmware, and/or software).

Certain embodiments of mote devices can also be configured to display images, similar to those displays, screens, etc. that can be used as computer monitors, televisions, theaters, signs, billboards, personal display assistants, etc. In certain embodiments of mote devices, each mote device can actuate one or more colors (in certain instances, all the colors) for one or more picture elements (pixels) for the display. The color levels can be adjusted by the mote device depending upon the resolution, or quality, of the display. As such, certain embodiments of the mote device(s) can act as an actuator for a display.

In some exemplary implementations, the inertial device 160 can be implemented using one or more inertial transmitters (e.g., inertial force transmission devices) and/or one or more inertial receivers (e.g., inertial force reception devices) and/or one or more supporting devices (e.g., supporting hardware, firmware, and/or software). Those skilled in the art will recognize that although a quasi-stack architecture can be utilized herein for clarity of presentation, other architectures may be substituted in light of the teachings herein. In addition, although not expressly shown, those having skill in the art will appreciate that entities and/or functions associated with concepts underlying Open System Interconnection (OSI) layer 2 (data link layers) and OSI layers 4-6 (transport-presentation layers) are present and active to allow/provide communications consistent with the teachings herein. Those having skill in the art will appreciate that these layers are not expressly shown/described herein for sake of clarity, and are not intended to be limiting in scope.

Many embodiments of mote devices are configured to sense a number of sensed parameters. For example, the mote device 11, as illustrated in FIGS. 2 and 3, can be configured to sense light, electrical/magnetic level, pressure, temperature, volume, and/or inertia. These particular parameters as described with respect to FIGS. 2 and/or 3, or throughout this disclosure, are intended to be illustrative in nature and not limiting in scope. Sensors for mote devices can be configured to sense a wide variety of parameters. Certain embodiments of mote devices 11 can be configured during device configurations (e.g., by the mote device designer and/or user) to sense particular prescribed parameters, and that mote device will sense only those prescribed parameters during its intended lifetime. By comparison, certain embodiments of mote devices 11 can be reconfigured during normal operation to sense different prescribed parameters. During configuration and/or reconfiguration, certain embodiments of mote devices 11 can be connected to or modified to a particular sensing device, such as providing a new hardware, software, firmware, etc. During reconfiguration, other embodiments of mote devices 11 can be reconfigured such that certain sensing devices that had previously been integrated in, or associated with, the mote devices can be actuated, such as by reconfiguring the hardware, software, firmware, etc.

FIG. 3, depicts an exploded view of an embodiment of the mote device 200 (that represents one example of the mote device 11, as described herein with respect to FIG. 1). The mote device 200 can form a part of a mote-appropriate network. The mote device 200 as described with respect to FIG. 3 is illustrated as similar to mote device 11 (e.g., described with respect to FIG. 2), but with the addition of log creation agent 202, mote-addressed sensing/control log 204, and mote-addressed routing/spatial log 252.

One embodiment of a mote-addressed sensing/control log 204, as described with respect to FIG. 3, can be configured to sense particular illustrative but non-limiting parameters of: entries of light device information, electrical/magnetic device information, pressure device information, temperature device information, volume device information, inertial device information, and antenna information. Examples of light device information can include measures or productions or light based on brightness, saturation, intensity, color, hue, power (e.g., watts ), flux (e.g., lumens), irradiance (e.g., Watts/cm²), illuminance (lumens/m², lumens/ft²), pixel information (e.g., numbers of pixels (e.g., a very small mote image capture device), relative pixel orientation)), etc. Examples of electrical/magnetic device information can include measures of field strength, flux, current, voltage, etc. Examples of pressure device information include measures of gas pressure, fluid pressure, radiation pressure, mechanical pressure, etc. Examples of temperature device information include measures of temperature such as Kelvin, Centigrade, and Fahrenheit, etc. Examples of inertial device information include measures of force, measures of acceleration, deceleration, etc. Examples of antenna information include measures of signal power, antenna element position, relative phase orientations of antenna elements, delay line configurations of antenna elements, beam directions, field of regard directions, antenna types (e.g., horn, biconical, array, Yagi, log-periodic, etc.), etc.

In the implementation, as described with respect to FIG. 3, a log creation agent 202 can utilize a computer program that can be resident in the mote device 200, that executes on a processor of mote device 200 and that constructs and/or stores mote-addressed sensing/control log 204, and/or mote-addressed routing/spatial log 252 in memory of mote device 200. In some implementations, log creation agent 202 is pre-installed on mote device 200 prior to mote device 200 being added to a mote-appropriate network, while in other implementations log creation agent 202 crawls and/or is transmitted to mote device 200 from another location (e.g., a log creation agent at another mote or another networked computer (not shown) to thereby replicate or clone itself, and transmits that log clone to mote device 200). In yet other implementations, the log creation agent 202 can be installed at a proxy (not shown) for mote device 200. Such logs can be accessed, with certain embodiments of the maintaining devices, to determine whether the individual mote devices are achieving their goals as per the mote network.

The structure and operation of each mote device 200 or 11, as described with respect to FIGS. 1, 2, and/or 3, are intended to be illustrative in nature and represents a number of illustrative embodiments of mote device structure and operation. Mote devices continue to undergo development, and it is to be understood that other mote structures and operations (such as is described in the articles, publications, and research as described herein) are also intended to be within the scope of the present disclosure as long as such mote structures and operations satisfy the claim limitations of the present application, as interpreted based on the present disclosure.

In certain embodiments of this disclosure, the systems and/or processes transfer their instructions in a piecewise fashion over time. In some applications, motes can be considered as relatively low-power and/or low bandwidth devices, and thus in some implementations the system(s) and process(es) described herein allow many minutes (e.g., hours, days, or even weeks) for herein described agents and/or processes to migrate to and establish themselves at various motes. The same can be true for transmission of information among motes in that in some implementations such transmission may be done over the course of hours, days, or even weeks depending upon bandwidth, power, and/or other constraints. In other implementations, the migrations and/or transmissions are accomplished more rapidly, and in some cases may be accomplished as rapidly as possible.

III. Examples of Mote Device Maintaining Devices

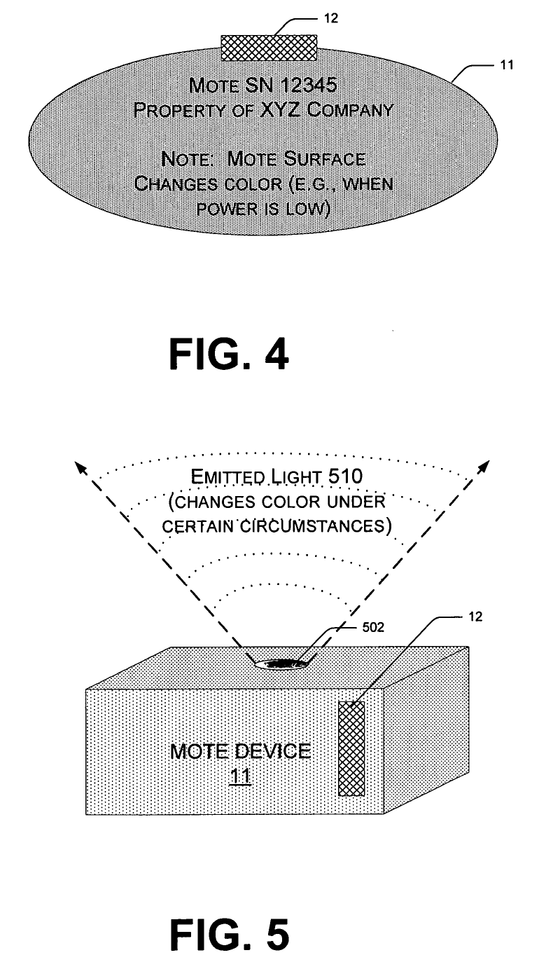

There are a variety of techniques by which the mote device 11 can indicate to other devices (e.g., a maintaining device) that the mote device 11 can be, or is configured to be, maintained, identified to be maintained, and/or attended to. The particular shape or surface configuration of the mote devices 11 (and the associated antenna to the mote devices) as illustrated in FIGS. 4-6 are intended to be illustrative in nature, and not limiting in scope. Mote devices can be constructed in any desired shape. The embodiment of the mote device 11, as described with respect to FIG. 4, can be configured such that at least one of its surfaces changes color to identify to a maintaining person or maintaining device when it should be maintained. In one embodiment of the mote device 11 as described with respect to FIG. 4, the color changes when, for example, the power supply of the mote device drops below a prescribed power level. Such change in color(s) of the mote device can be used by a person or a mechanism to recognize those mote devices that are below a prescribed energy level.

In certain embodiments, a mechanism that can be used to change the color (or some other detachable condition or position) of the mote device 11 can include a status indicator portion. Such a detectable change to the mote device could be detected by many embodiments of the maintenance device such as a change in color of the mote device when the mote device is indicating that it should be collected. For example, a power-sensing maintaining device that can sense a power level of certain mote devices. In certain embodiments, the status indicators can be formed as, or attached to, a portion or the entirety of an external surface of one or more mote devices 11. As such, causing the status indicators (that can, in certain embodiments, be configured as tags) to change color using some chemical, fluorescent, phosphorescent, mechanical, or other technique, can effectively result in changing the outward appearance of certain embodiments of the mote device. One example of a mechanical change in color on the mote devices may include, but is not limited to, physically “pumping” some liquid into a chamber of the mote device that is visible from the outside of the mote device.

Another example of a mechanical change in color may include painting or otherwise coloring two surfaces of the mote devices in two colors. As such, during normal operation, one color of the mote that is typically facing upwards will be painted a first color. As particular mote devices are identified as those to be maintained, the mote devices can be “flipped over” using, e.g., some maintaining devices, identifying device, or even a positional actuator located within the mote device itself, such that the new surface is being exposed on the maintaining device is of a different color that can be identified by the maintaining device and/or an individual. As such, certain embodiments of mote devices could vibrate, click, buzz, provide a voice signal, provide a signal of some frequency that may or may not be audible by human ears but might be to the maintaining device or controller, provide a light signal, change color, change shaper and/or position, etc. Such change of an outward appearance of certain embodiments of the mote device can be detected by a human, or alternatively a mechanism that can sense color, vibration, reflectance, or the particular characteristic being identified by the maintaining device or individual. In certain embodiments, image processing and/or filtering techniques can be used to identify locations of mote devices, or the status indicator attached thereto, that have changed color. In certain embodiments, the maintaining device can be configured to automatically recognize those colors of the mote devices that indicate that the mote devices should be maintained. For example, consider in one embodiment, the mote device turns to a particular color when it's power and/or energy level is low, and perhaps to another color when data-storage or transfer becomes an issue.

As such, it may be beneficial for the maintaining device to be capable of recognizing mote devices having a particular color and thereupon may indicate that the mote device should be maintained. In certain embodiments, a filtering device can be used by a maintaining device to monitor an area that mote devices are located for a particular color that would indicate that the mote device should be maintained (e.g., collected, reconfigured, replaced, destroyed, discarded, etc. as described herein). When that particular color is received by the maintaining device, then the maintaining device can identify that particular mote device to a person or mechanism that can maintain the mote device, or alternatively maintain the mote device itself. This scenario represents an illustration of one embodiment of the maintaining device or mechanism that can be used to maintain one or more mote devices, while it is to be understood that other embodiments of maintaining devices can also be utilized that also rely upon the color of one or more surfaces of the mote devices.

A number of embodiments of status indicators can be utilized to change the color of a surface of one or more mote devices 11, as described with respect to FIG. 4. Certain embodiments of status indicators can include, but are not limited to: a chemical status indicator or a fluorescent status indicator, which can be utilized to change color of a surface upon a prescribed condition. The structure and operation of a chemical status indicator and/or fluorescent status indicator are generally understood, and will not be described in further detail herein. Certain embodiments of mote devices can change color from their natural background (e.g., green for mote devices in a field, or gray or black for mote devices on a roadway) to an easily-detectable color (e.g., orange for mote devices in a field) to ease maintaining by a person or optical-based maintaining device.

Another embodiment of mote device 11 can be configured to emit light of a recognizable color, brightness, blinking rate, etc. when it is desired that the mote be maintained by, for example, the maintaining device 50. As such, the emitted light can be utilized (for example by a person or the maintaining device 50) to identify one or more mote device(s) and/or identify a location of the one or more mote device(s). In one embodiment, a light emitting diode (e.g., LED) or display device that can be actuated based on a parameter sensing, for example, that the mote device has relatively low-power. As such, the mote device 11 can be configured to emit a particular color if it is desired that mote device, for example, be maintained by the maintaining device based, at least in part, on the color of the mote device. In certain embodiments, for example as described with respect to FIG. 5, the mote device 11 includes a light source 502, that can be configured to generate light of a desired color, blink at a desired rate, or to provide another desired optical characteristic, etc. when it is desired to have the mote maintained or attended to. In certain embodiments, the light device 502 can include at least one light emitting diode(s) which has been designed to provide a signal 510 that can, in this embodiment, include a considerable amount of light using relatively little power. As such, the maintaining device, or alternatively a user of the maintaining device, should be able to recognize and/or locate those mote devices that are to be maintained based on the signal 510 that includes light from the light source 502. As such, the light emitted from the light source 502 can be selected to indicate one or more conditions of the mote device 11. In certain embodiments, the light source 502 can be a relatively low-powered device, such that the mote device 11 will be able to emit a light even under certain circumstances that the mote device has insufficient power to operate properly.

A variety of techniques may be utilized to approve the maintaining or attending to of mote devices that are of a particular color or are emitting light. For example, if a user is monitoring mote devices within an interior space such as a building, then it may be desired to turn out other lights within the room, building, outdoor area, etc. where the mote device is located to determine which ones of the mote devices are generating light from the light source 502. Alternatively, light of a particular frequency may be generated from the light source, that is not a similar frequency to the light in the area around the mote device 11. For example, the light source 502 can be configured to emit infrared or ultraviolet light; and a suitable filter can thereupon be used by the maintaining device to filter out light that does not correspond to that emitted by the light source 502. As such, the ambient light of the region (that differs in frequency or color from the light of the light source 502) does not hide the location of the light source and mote device, and thereupon the location(s) of the light source(s) and mote device(s) can be readily detected. In certain embodiments, light of a different frequency than provided by the light source 502 can be filtered out to allow a user, or a detecting portion associated with the maintaining device, to determine whether one or more of the light sources from the mote devices 11 are emitting light of that particular frequency. Such filtering techniques can be utilized by a person or imaging portion of the maintaining device to improve locating and/or identifying such mote devices that should be maintained.

Some implementations shown/described herein include various separate architectural components. Those skilled in the art will appreciate that the separate architectural components are so described for sake of clarity, and are not intended to be limiting. Those skilled in the art will appreciate the herein-described architectural components, such reporting entities, logs, and/or device entities, etc. are representative of substantially any architectural components that perform in a similar manner. For example, while some implementations show reporting entities obtaining information from logs created with device entity data, those skilled in the art will appreciate that such implementations are representative of reporting entities obtaining the data directly from the device entities. As another example, while some implementations show reporting entities obtaining information produced by device entities, those skilled in the art will appreciate that such implementations are representative of executing sensing of parameters, or some other operation, at the mote device 11 or 200. In certain embodiments, the mote devices 11 or 200 can extract and/or transmit similar information as that described in the relation to the reporting entities and/or device entities. For example, some multi-mote log creation agent making a query of a database entity resident at the mote devices within the mote network, where the database entity would perform in a fashion similar to that described in relation to reporting entities, logs, and/or device entities, etc. Thus, those skilled in the art will appreciate that the architectural components described herein are representative of virtually any grouping of architectural components that perform in a similar manner.

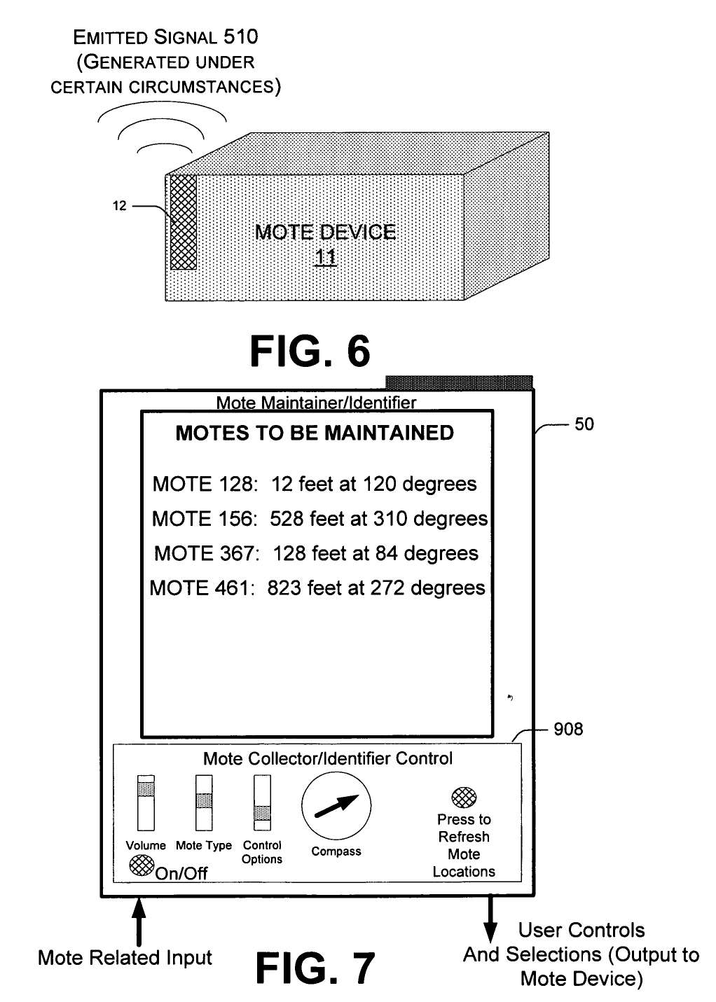

As described with respect to FIG. 6, certain embodiments of mote devices 11 can generate a signal (optical, acoustic, vibration, or other) using the antenna 12 or other suitable portion of the mote device. In certain embodiments, the signal 510 can indicate the mote device should be maintained by the maintaining device 50 for any of the reasons described in this disclosure. For example, perhaps the mote device is reaching a relatively low energy and/or power state, and could be maintained to be recharged and/or replaced. In another embodiment, perhaps the memory storage capabilities of the mote device is reaching it's filled state.

This disclosure provides certain embodiments of the maintaining device 50, as described with respect to the FIG. 1. FIGS. 7 and 8 show two embodiments of maintaining devices 50. Certain embodiments of the maintaining device 50 are designed to maintain either those mote devices that are suitable to be maintained as determined by the maintaining device (or a user thereof), or alternatively the mote device indicates to the maintaining device that the mote device should be maintained. The embodiment of the maintaining device 50 as described with respect to FIG. 7 is intended to be used by an individual, and identified to the individual identities and/or locations of the mote devices 11 that are to be captured. The embodiment of the maintaining device 50 as described with respect to FIG. 8 is intended to be programmed to automatically maintain those mote devices 11 that are to be maintained. Consider that one embodiment of the maintaining device 50, as described with respect to FIG. 8, can contain a securing portion 802 and a transporting portion 804. The securing portion 802 can be configured to somehow retain, grab, hold, adhere to, or somehow otherwise secure the mote device during transport of the mote device. The transporting portion 804 can be configured to transport the mote device 11 to a desired location, such as to a recharge location, to a repair/replacement base, to a computer/controller 18 as described above to transfer at least some of its data, or to a discard location. The particular configuration of the securing portion 802 and the transporting portion 804, as illustrated in and described with respect to FIG. 8, are intended to be illustrative in nature and not limiting in scope. The mote devices 50, as described with respect to FIGS. 7 and 8, are intended be illustrative in nature, and not limiting in scope.

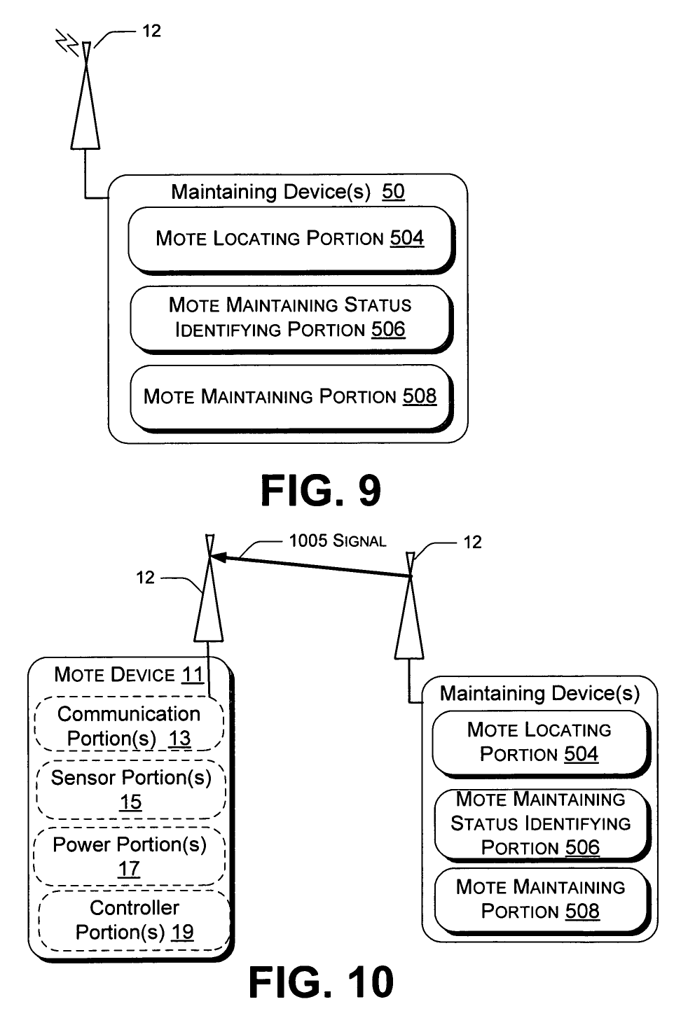

The embodiment of the maintaining device 50, as described with respect to FIG. 9, represents one generalized embodiment of the maintaining device that determines those mote devices that are to be maintained. The embodiment of maintaining device 50, as described with respect to FIG. 9, can include, but is not limited to: a mote locating portion 504, a mote maintaining status identifying portion 506, and mote maintaining portion 508.

Certain embodiments of the mote locating portion 504, as described with respect to FIG. 9, can be configured to locate one or more mote devices such as, but not limited to, providing the exact geographic position of each mote device to be maintained as could be understood by the maintaining device(s) 50. Other embodiments of the mote locating portion 504 can be configured to provide a relative geographic position of each mote device to be maintained with respect to the maintaining device 50 in a manner the can be understood by the maintaining device. As such, many embodiments of the mote locating portion 504 can utilize positional information, such as provided by global positioning systems (GPS, many of which are commercially available), RNAV, very-high-frequency omni-directional range (VOR), radio locating/ranging, or other positioning devices. In other embodiments, the mote locating portion 504 can define locations of motes with respect to some other coordinate axis. For example, a mote locating portion 504 that deals with mote devices located within an automobile engine or an interior of a power plant could rely upon some coordinate axis defined with respect to that automobile engine or interior of the power plant. Additionally, a mote locating portion 504 that maintains mote devices that are located within a room can establish coordinates with respect to that room. As such, the selection of a particular coordinate axis by which the mote locating portion 504 operates may depend largely upon the location of the mote devices themselves, and a user of the mote devices could determine a convenient coordinates axis depending upon the location-of the mote devices to be maintained. These examples of positional information sources are not intended to be limiting in scope.

Certain embodiments of the mote maintaining status identifying portion 506 can identify those mote devices 11 that are intended be maintained. By comparison, the mote maintaining portion 508 can be configured to maintain those motes identified by the mote maintaining status identifying portion 506. In certain embodiments, similar to as described with respect to FIG. 7, the identification performed by the mote maintaining status identifying portion 506 can be performed by an individual with the maintaining device 50 (in one embodiment by following directions as to have the maintaining device locate each mote device to be maintained). Thereupon, as the user reaches each mote device to be maintained in order, the user can physically pick up each mote device. As such, in many embodiments, the maintaining devices 50 can be manually configured such that the maintaining devices indicate the location of the mote devices to be maintained, and a user who is associated with the maintaining device manually picks up those mote devices.

In certain embodiments, similar to those described with respect to FIG. 8, the mote maintaining portion can be largely automated, such that identification of the location of each mote be maintained, as provided by the mote maintaining status identifying portion 506, can be input to the mote maintaining portion 508. As such, the mote maintaining portion 508 can rely upon a variety of automated techniques (e.g., such as noted to be understood to those skilled in the robotics arts), to maintain those particular mote devices that are to be maintained. For example, certain embodiments of the mote maintaining portion 508 of the maintaining device 50 can include a grasping mechanism, shoveling mechanism, a grabbing mechanism, a holding mechanism, or some other type of mechanism by which the mote device can be held in position by the maintaining device 50. In certain embodiments, the maintaining device can then transport the mote device to a desired location. Certain embodiments of the mote maintaining portion 508 of the maintaining device 50 can utilize some type of transport mechanism, such as, but not limited to: wheels, tracks, treads, steppers, sleds, etc. or other further techniques by which the maintaining device 50 can be transported across the type of area from which the particular mote device 11 is being maintained.

Certain embodiments of the maintaining device could be operationally “directed” at those mote devices that could be maintained using, for example: optical sensed color that could be output by the mote devices (e.g., as described with respect to FIGS. 4 or 5), positional information and/or maintenance information that could be provided by the mote devices, an audio, light, or other signal that could be output by the mote devices and thereupon detected by the maintaining device, and/or any other type of signal or indicator (e.g., a status indicator) that could indicate the mote device is ready to be maintained and/or where to locate that mote device to be maintained. Other embodiments of the maintaining device 50 could propel themselves (in a random or organized fashion) around an area where mote devices are located, until they come in contact with those mote devices that are to be maintained.

There are a variety of techniques by which the maintaining device 50, as described with respect to FIG. 1, can maintain one or more of the mote devices 11. One embodiment of maintaining device 50 can be associated with an individual, and can assist to indicate to the maintaining device or maintaining person a particular location of the mote device. In one embodiment, for example, the maintaining device 50 can indicate a reference distance and a reference angle to any mote device, or alternatively a particular mote device. For example, a mote device 11 to be maintained can be 20 feet away from the maintaining device at an angle of 120° (or any other suitable distance and/or angle or similar coordinate system). Certain embodiments of the maintaining device 50 can utilize ranging techniques, similar to those techniques developed for such positioning applications such as radar and global positioning system, many of which are commercially available and will not be described further herein.

Certain embodiments of the maintaining device 50 can then propel itself, or be carried by a user, to the maintaining device, and maintain the mote device using a suitable mechanism. Certain embodiments of the maintaining devices 50 could repair, reconfigure, repower, discard, or apply energy to the mote device (perhaps with the assistance of a person), and even perhaps return the mote device to its original location after performing its work at the location of the mote. Certain automated embodiments of the maintaining devices 50 could return one or more maintained mote devices to another location to work on or repower the mote devices. Certain embodiments of maintaining devices could return the repaired mote devices to the same location, or alternatively reconfigure the mote device to operate at a different location. Alternatively, certain embodiments of mote devices can be designed to configure themselves where they are located. These maintaining techniques and scenarios by different embodiments of the maintaining device 50 are intended to display the vast variety or scenarios by which mote devices can be maintained for a variety of purposes, and is not intended to be limiting in scope. As such, many embodiments of the maintaining device 50 (e.g., automated, to be used by a person, and/or other configurations of maintaining devices such as described herein) can perform a variety of maintaining techniques.

IV. Examples of Signal Energy Transfer to Mote Devices

Certain embodiments of the mote device 11, as described with respect to the FIGS. 1 to 3, can rely on power or energy level for a variety of reasons including, but not limited to, extending useful device life for the mote device(s), enhancing reliability of the mote device(s), etc. This disclosure provides a variety of techniques by which the power/energy level of the mote device can be extended using energy contained within a signal 1005 provided by the maintaining device 50, or some other device. In certain embodiments, the signal 1005 can provide for querying, controlling, responding to, signaling, and/or a variety of other operations of the mote devices within the mote network. The signal 1005, however, contains some amount of energy that (perhaps when converted to a desired frequency) would be useful for the mote device(s).

FIG. 10 illustrates one embodiment of the maintaining device 50, that is providing a signal 1005 that can to be received by the mote device 11. As described in this disclosure, many embodiments of mote devices 11 can include a power portion 17, which can in certain embodiments include, for example, a battery such as a double-A battery, a power cell, etc. In certain embodiments, the power portion 17 can be rechargeable. Increasing the charge of the rechargeable power portion 17 can thereupon increase the energy level, an effective device life, and longevity in certain embodiments of the mote device 11, especially when the energy level of the mote device 11 is low. As such, this disclosure provides a mechanism by which energy contained within the applied signal 1005 can be utilized to recharge the power portion 17, if the power portion is rechargeable.

In certain embodiments of the mote device 11, the communication portion 13 is to be configured to convert a frequency of the received signal 1005. As such, even if the signal 1005 is not of a frequency that can be utilized by the power portion to charge the under-charged power portion 17, the communication portion 13, or an associated portion, can convert the frequency of the electromagnetic radiation received as the signal 1005 to a frequency that can be used to charge the power portion 17. By increasing the charge of the mote devices 11, the effective life of certain embodiments of mote devices can be extended. Under certain scenarios, the maintaining device 50 can be scheduled to routinely consider some, many, or all of the mote devices in a mote network for maintaining, collection, attending to, etc., and the energy from the signal 1005 can effectively recharge, to some degree, at least some of the mote devices that are configured to be recharged. As such, it is to be understood that this disclosure provides a number of techniques by which signals 1005, as applied from the maintaining device 50, can be utilized to increase the energy or power level of an undercharged mote device 11. While FIG. 10 illustrates the maintaining device 50 generating the signal 1005, it is to be understood that such signals 1005 can be provided by a wide variety of devices including, but not limited to: the maintaining device 50, the computer/controller 18, another mote device 11, or any other device that can be configured to produce a signal (that can be converted to utilize the signal's energy).

It may be desired to utilize the signal 1005 to be produced by the maintaining device 50, and the maintaining device 50 can utilize the mote maintaining status identifying portion 506 to determine a status of the mote device 11. Particularly, as described with respect to FIG. 9, whether the mote device 11 is undercharged can be one status item of the mote device 11 that can be determined by the mote maintaining status identifying portion 506 of the maintaining device 50. As such, the maintaining device 50 can be provided with a number of options if it is determined that there is one or more undercharged mote devices 11. In one embodiment, the maintaining device 50 can generate the signal 1005, and even perhaps generate other signals that can be utilized by the mote device 11, and convert the signal(s) to a frequency effective to recharge the power portions 17. Alternatively, the maintaining device 50 can maintain the mote device 11 to properly maintain, charge, configure, attend to, or replace the mote device. The technique(s) used by the maintaining device 50 upon interaction with the one or more mote device(s) can be programmed in the maintaining device, or alternatively can be selected by user input (e.g., via a remote link—not illustrated) to the maintaining device. A variety of techniques and/or mechanisms (that can include, but may not be limited to, software, hardware, firmware, electromechanical, and/or mechanical aspects) can be utilized to allow individuals to control the maintaining operations of the maintaining device. For example, in one embodiment, a user can interface with the controller user interface located directly on the maintaining device. In other embodiments, the user can communicate with the maintaining device utilizing a distinct remote-control unit (not shown), which is configured to provide wireless control communications with the maintaining device. In certain embodiments, the energy from other signal(s) transmitted by the maintaining device 50, the computer/controller 18, and/or another mote device 11 can be utilized to recharge the power portion 17.

In many embodiments, if the maintaining device 50 is providing the signal 1005 for the purpose of recharging the mote device 11, reposition the mote device 11, attend to the mote device, or perform some other operation with respect to the mote device 11, then the mote device may be configured to understand that this is the purpose of the signal. As such, a variety of communication techniques can be utilized between the maintaining device 50 in the mote device 11 to set up the transfer of energy via the signal 1005. For example, the mote device 11 should be aware of the frequency of the signal 1005, so that the mote device 11 can ensure that it is able to convert the electrical energy of that signal into a frequency that can be utilized to charge the undercharged rechargeable power portions 17.

While the FIG. 10 embodiment illustrates the signal 1005 that charges the power portion 17 of the mote device 11 as originating from the maintaining device 50, it is to be understood that the signal 1005 can be provided by a variety of other devices such as a charging device. For example, in certain embodiments, the maintaining device 50, a person using the maintaining device, or a person acting alone can locate those mote devices 11 that need to be charged. Thereupon, the maintaining device 50 of a person can position a signal-charging device (not shown) that emits a charging signal in sufficiently close proximity to the rechargeable mote device for a sufficient duration to charge the mote device using the signal 1005. Alternatively, the mote device can be returned to a remote location for charging either using traditional charging techniques or using a signal-charging technique. Within this disclosure, the signal 1005 can by configured as any type of electromagnetic radiation (including radio, electric, optical, infrared, ultraviolet) whose energy can be converted into a form which can at least partially charge the power portion 17.

By periodically utilizing the maintaining device 50 and/or charging device to charge the mote devices, the energy levels of the mote devices in a mote network can be maintained to ensure and monitor for substantially continual operation. As such, the reliability of operation of certain embodiments of mote devices and their networks can be ensured.

The maintaining device 50 can thereby be configured to perform a wide variety of operations with respect to the mote device 11, that can include, but are not limited to: maintaining the mote device, identifying those mote devices that need maintaining, and/or charging an undercharged rechargeable mote device 11.

V. Examples of Computers/Controllers to be used with Mote Devices Mote devices 11 can be applied to a large variety of sensing, measuring, and/or controlling applications, including but not limited to, sensing a variety of parameters as described with respect to FIGS. 1 to 3. It is envisioned that the role of a single mote device 11 can be changed, such as by reconfiguring the user interface, downloading different software, hardware, and/or firmware into the mote device, etc. Changing the role of the mote device 11 can provide different sensing applications based at least in part on varying the configuration or operation of software, hardware, or firmware of a computer/controller 18 that can be configured to interface with the mote device 11. This portion describes certain embodiments of the computer/controller 18 that may be configured to allow such functionality and alterability with respect to the mote device(s) 11, the computer/controller(s) 18, and/or the maintaining device(s) 50. As such, the processor 605, the memory 607, the circuit 609, and/or the input/output 611 are illustrated in each of the mote device(s) 11, the computer/controller(s) 18, and the maintaining device(s) 50 since each of these devices can be configured to perform processing operations and/or sense parameters at least partially using the mote devices 11.

Many embodiments of mote devices 11 utilize processing, timing, filtering and/or other techniques when performing a variety of sensing operations. Such processing, timing, filtering, and/or other techniques can be at least partially performed and/or controlled within each individual mote devices 11 by using the controller portion 19. In many embodiments, the processing, timing, filtering, and/or other techniques can be at least partially controlled, externally of the mote devices 11, using the computer/controller 18. In many embodiments, the controller portion 19 integrated in certain embodiments of the mote device 11 can interoperate with the computer/controller 18 using known networking techniques. As such, depending upon the particular mote design, application, configuration, etc., a certain amount of the control of the operations of each mote device 11 can be provided either within the controller portion 19, or alternatively within the computer/controller 18.

FIG. 1 shows one embodiment of the computer/controller 18 (which can be provided by a computer, microprocessor, microcontroller, etc.) as can be integrated within certain embodiments of the mote devices 11 to assist in providing the sharing of at least portions of data and/or other information associated with those mote devices. Certain operations and/or structures, as described with respect to the computer/controller 18 which is distinct from the mote device 11; can also apply to the controller portion 19 that is integrated within the mote device and/or the maintaining device 50. As such, the particular location of software, hardware, and/or firmware that controls operation of the mote device(s) 11 can be distributed across the mote network, at least to those locations including the mote devices 11, the the maintaining device 50, and/or the computer/controller 18. Certain sensing-related aspects, such as synchronization and/or designation of aspects as described within this disclosure, can be performed by the computer/controller 18, the controller portion 19, and/or the maintaining device 50. As such, in different embodiments, the mote device(s) can be operably coupled to each other, the maintaining device 50, and/or the computer/controller 18.

As described within this disclosure, multiple embodiments of the mote devices 11 are able to transfer a variety of data and/or information, etc. to each other via the antennas 12. One embodiment of the computer/controller 18 (that therefore may also be included in the controller portion 19 and/or the maintaining device 50) includes a processor 605 such as a central processing unit (CPU), a memory 607, a circuit or circuit portion 609, and an input output interface (I/O) 611. In certain embodiments, the I/O 611 may include a bus (not shown). In certain embodiments, the processor 605 can have a more limited capacity than perhaps a CPU, such as would occur if the computer/controller 18 included a microprocessor or microcomputer. Different embodiments of the computer/controller 18 can be a general-purpose computer, a specific-purpose computer, a microprocessor, a microcontroller, a personal display assistant (PDA), and/or any other known suitable type of computer or controller that can be implemented in hardware, software, electromechanical devices, and/or firmware. Certain portions of the computer/controller 18 can be physically or operably configurable in each mote device as described with respect to FIGS. 1 to 3. In certain embodiments of the mote device, the processor 605 as described with respect to FIG. 1 performs the processing and arithmetic operations for the computer/controller 18. The computer/controller 18 controls the signal processing, database querying and response, computational, timing, data transfer, and other processes associated with the mote device. In certain embodiments, one or more simplified versions of the computer/controller 18, the controller portion 19, and/or a similar controller in the maintaining device 50 (not illustrated) can be provided with respect to FIG. 1, and could be configured to provide a transfer of data or other information and/or data between multiple mote devices, the computer/controller 18, and/or the maintaining device 50.

Certain embodiments of the memory 607 include random access memory (RAM) and read only memory (ROM) that together store the computer programs, operands, and other parameters that control the operation of the mote device. In cerain embodiments, the memory can include flash memory or other similar memory components. The memory 607 can be configurable to contain the data or information obtained, retained, or captured by that particular mote device 11 (that may be configurable in different embodiments as the peripheral mote device of the obtaining mote device) such as are used to sense or measure a variety of parameters. Certain embodiments of mote devices can also be configured to actuate a variety of operations, such as turn a light (e.g., light emitting diode) on or off or control a display, computer monitor, etc.

In certain embodiments, the bus (not illustrated) can be configurable to provide for digital information transmissions between the processor 605, circuits 609, memory 607, and/or the I/O 611 as described with respect to FIG. 1. In this disclosure, the memory 607 can be configurable as RAM, ROM, flash memory, semiconductor-based memory, or any other type of memory that is configurable to store data or other information pertaining to motes. The bus also connects I/O 611 to the portions of the mote devices that either receive digital information from, or transmit digital information to, other devices of the mote network 10.

Many embodiments of the antenna 12 can be configured as both transmitting and receiving devices. As such, each one of the mote devices 11, the maintaining device 50, and/or the computer/controller 18 can be configured to transmit information to other devices, as well as to receive information from other devices. Each antenna 12 can be configured to provide effective communications to other devices, and therefore can include, but are not limited to, the radio frequency signals, wireless signals, optical signals, infrared signals, etc.

The memory 607 can provide one example of a memory storage portion that can, for example, store information or data relating to mote sensing, and/or computer instructions relating to device operations, etc. In certain embodiments, the monitored value includes, but is not limited to: a percentage of the memory 607, a certain amount of mote information that is stored in the memory 607, or at other locations associated with the mote information.

The memory 607 can be configured to provide for overflow, primary, secondary, or additional ability for the memory 607 of certain embodiments of the mote device 11, the maintaining device, and/or the computer/controller 18 (e.g. when the monitored value of data within the memory 607 exceeds a prescribed value). Other embodiments of the memory 607 can be configurable as a mobile random access memory (RAM) device, a flash memory device, a semiconductor memory device, or any other memory device (that may or may not be distinct from the memory 607) that can store data or other information within the memory 607.

In certain embodiments of the mote device 11, the particular elements of the computer/controller 18 (e.g., the processor 605, the memory 607, the circuits 609, and/or the I/O 611) can provide a monitoring function to monitor the amount of data or information therein. Such a monitoring function by the mote device can be compared to a prescribed limit, such as whether the sensed information or data contained in the memory 607, the amount of data contained within the memory 607, or some other measure relating to the memory is approaching some level or value. In certain embodiments, the memory 607 stores data or information relating to the mote device. In certain embodiments the measure relating to the memory approaching some value may pertain to some sensed parameter, such as may be associated with the mote operation.

In certain embodiments, the I/O 611 provides an interface to control the transmissions of digital information between each of the components in the computer/controller 18. The I/O 611 also provides an interface between the components of the computer/controller 18 and different portions of the mote device. The circuits 609 can include such other user interface devices as a display and/or a keyboard (which can be varied, miniaturized, and/or be provided in a variety of graphical-based user interfaces for certain embodiments of mote devices).

VI. Examples of Interaction Between the Maintaining Device and a Normal Operating Mote Device

A number of embodiments or configurations of maintaining devices 50 are now described that can maintain one or more mote devices 11. In general, there may be a variety of reasons why certain mote devices should be maintained that include, but are not limited to, a) mote devices are failing to signal that they are still working, b) mote devices signaling that they are not working, and/or c) mote devices indicating that they have been working properly (e.g., the mote device has maintained data correctly over some prescribed time), but there is some reason to maintain the mote device (such as to collect data and return the mote device to service, or otherwise attend to the mote device).

In certain embodiments, the mote device can interface with the maintaining device to indicate that, for at least some of the reasons described above, the mote device is requesting attention and is ready to be maintained. As such, in many embodiments, the mote device 11 can (e.g., by transmitting maintaining attention requested signals), indicate to the maintaining device that is ready to be maintained.

Failing motes or mote devices may signal to be maintained for a variety of reasons using a variety of techniques. In one embodiment, a last know location (using absolute geographic position or location with respect to another mote device within the mote network) of the failing mote device may be transmitted based on information transmitted to (or inferred or calculated by) other motes. In certain instances, a failing mote can broadcast its failure and its location to neighbors, with the neighbor mote devices then storing the received location, and the mote devices can thereupon indicate (e.g., using a status indicator such as a tag) that they can provide information to locate or provide the status of another mote device(s), and can therefore act as a referral device by utilizing a “referral” status indicator. Other mote devices or other devices that are searching to maintain the failed mote device can obtain the last known location from the referral device in an effort to locate the failed mote device.

Flowcharts that can be associated with the mote devices are also described. Within the disclosure, flowcharts of the type described in this disclosure can apply to method steps as performed by a computer or controller. The flowcharts can also apply to computer/controller 18 that interfaces with the mote devices 11. In certain embodiments, the computer/controller 18 (that includes, e.g., a general-purpose computer or specialized-purpose computer whose structure along with the software, firmware, electro-mechanical devices, and/or hardware), can perform the process or technique described in the flowchart.

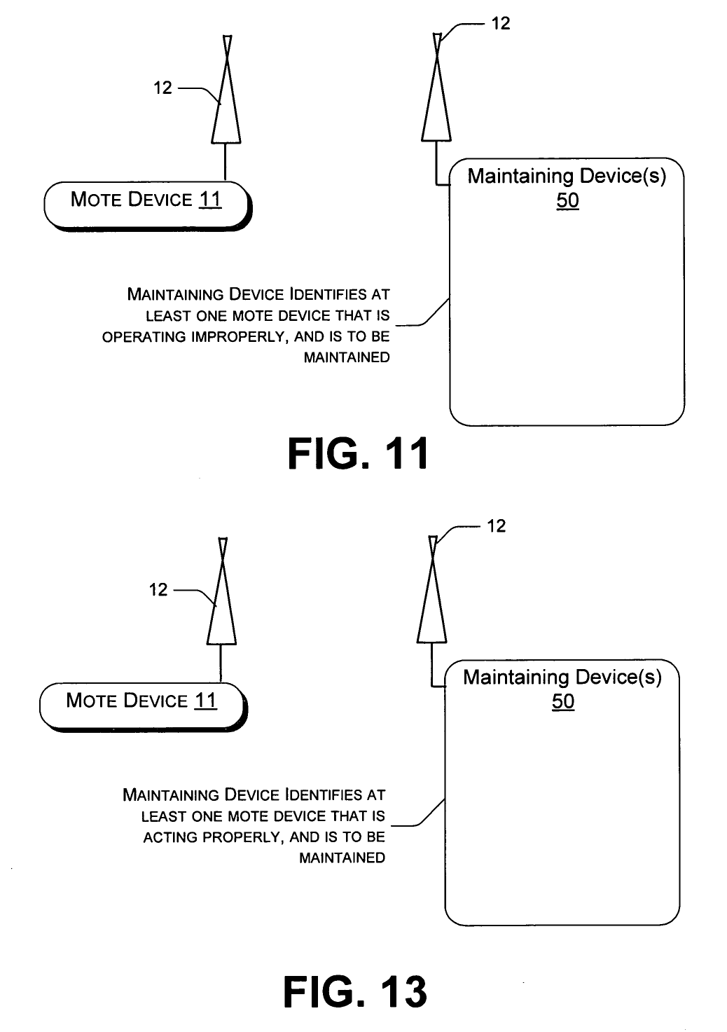

FIG. 11 shows one embodiment of a mote device 11, as described within this disclosure; certain embodiments of which can store parametric information sensed by the mote devices, and/or computer instructions, commands, etc. This disclosure thereby provides a mechanism by which one or more maintaining devices can identify those mote devices that should be maintained. In certain embodiments, the mote devices should be maintained when they might not contain sufficient power to provide normal operation to the mote devices. The power to the mote devices, as described in this disclosure, can be provided by batteries, power cells, or other power-related devices. In certain embodiments, once those mote devices that are to be maintained have been identified by the maintaining device, then certain embodiments of the maintaining device can utilize a variety of techniques to maintain the mote devices. For example, if the maintaining device is configured as described with respect to FIG. 7, then the user of the maintaining device will be able identify those mote devices that should be maintained, and their respective locations. By comparison, if the maintaining device 50 is configured to automatically maintain the mote devices, then upon identification of the mote devices to maintain, the maintaining device will automatically maintain those mote devices using robotic or other automated techniques.

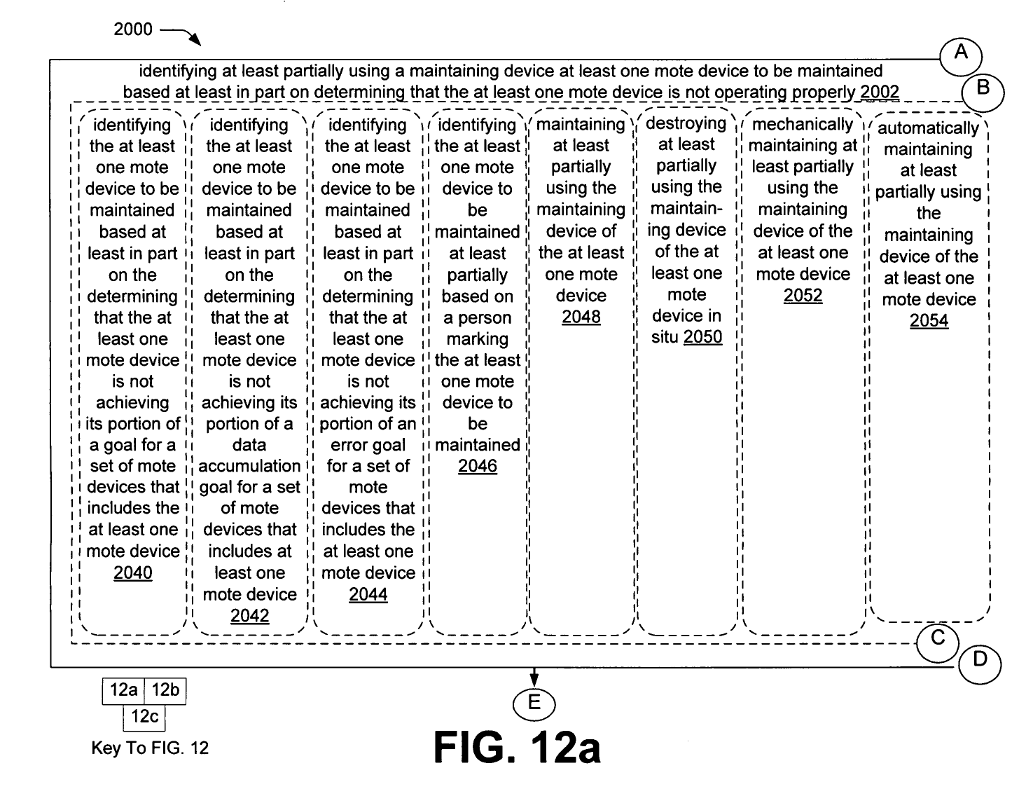

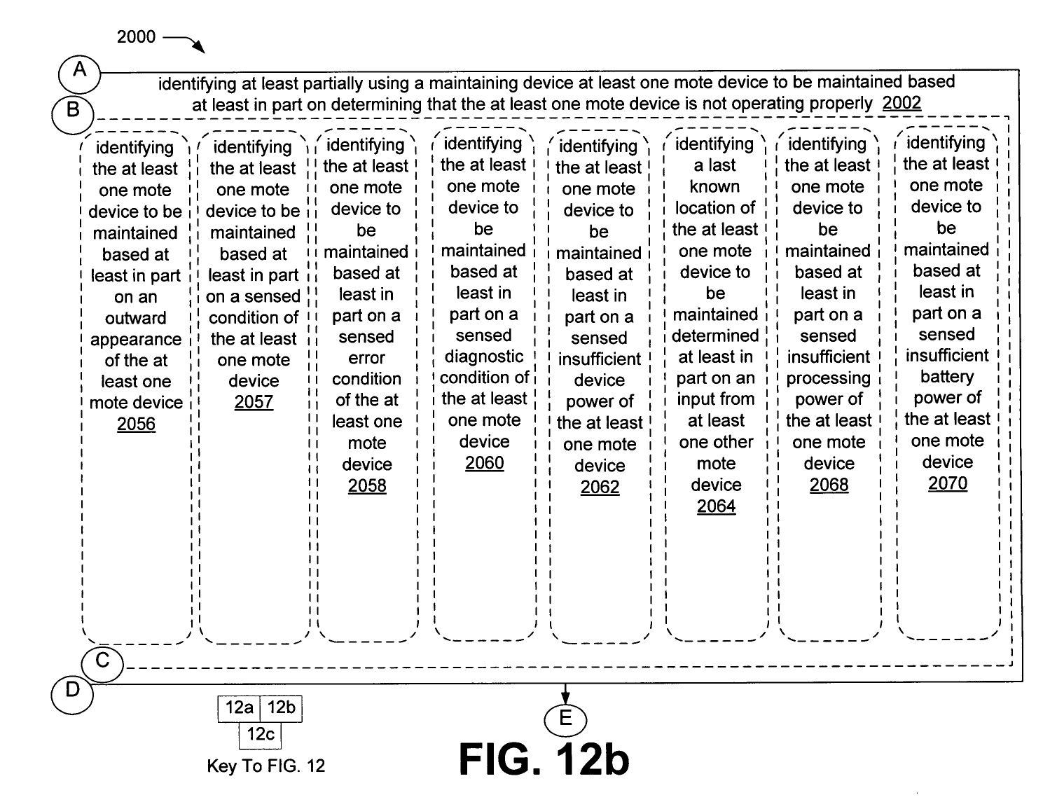

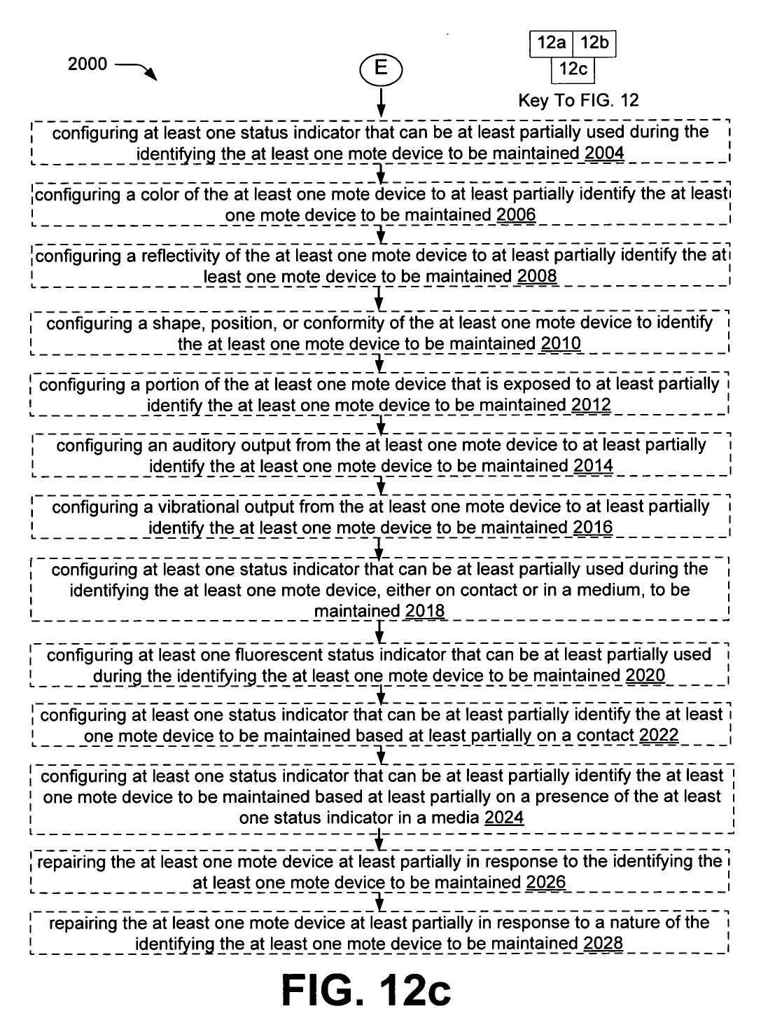

One embodiment of a high-level flowchart of a processing and/or sharing technique 2000 is described with respect to FIGS. 12a to 12c and includes, but is not limited to, operation 2002, as well as optional operations 2004, 2006, 2008, 2010, 2012, 2014, 2016, 2018, 2020, 2022, 2024, 2026, and/or 2028. Operation 2002 can include, but is not limited to, optional operations 2040, 2042, 2044, 2046, 2048, 2050, 2052, 2054, 2056, 2058, 2060, 2062, 2064, 2066, 2068, and/or 2070. The high-level flowchart of FIGS. 12a to 12c should be considered in combination with the mote device 11, as described with respect to FIG. 11. One embodiment of operation 2002 can include, but is not limited to, identifying at least partially using a maintaining device at least one mote device to be maintained based at least in part on determining that the at least one mote device is not operating properly. For example, as described with respect to FIG. 11, the maintaining device 50 identifies the mote device 11 as not operating properly. A variety of techniques, such as described in this disclosure, can be utilized by the maintaining device to identify the mote device such as, but not limited to, changes in color of the mote devices, changes in reflectivity of the mote devices, presenting the mote device in the new orientation that can be detected by the maintaining device, providing a light that can be detected by the maintaining device, etc. One embodiment of the identifying, at least partially using a maintaining device, at least one mote device to be maintained based at least in part on determining that the at least one mote device is not operating properly of operation 2002 can include operation 2040, that can include, but is not limited to, identifying the at least one mote device to be maintained based at least in part on the determining that the at least one mote device is not achieving its portion of a goal for a set of mote devices that includes the at least one mote device. For example, as described with respect to FIG. 11, the maintaining device 50 identifies at least one mote device 11 to be maintained based at least in part on the mote device not being able to achieve its goal for a number of mote devices arranged in the mote network. One embodiment of the identifying, at least partially using a maintaining device, at least one mote device to be maintained based at least in part on determining that the at least one mote device is not operating properly of operation 2002 can include operation 2042, that can include, but is not limited to, identifying the at least one mote device to be maintained based at least in part on the determining that the at least one mote device is not achieving its portion of a data accumulation goal for a set of mote devices that includes at least one mote device. For example, the mote device 11 can be located within a mote network, such that the mote device is not achieving its portion of the data accumulation goal for the set of mote devices within that mote network. One embodiment of the identifying, at least partially using a maintaining device, at least one mote device to be maintained based at least in part on determining that the at least one mote device is not operating properly of operation 2002 can include operation 2044, that can include, but is not limited to, identifying the at least one mote device to be maintained based at least in part on the determining that the at least one mote device is not achieving its portion of an error goal for a set of mote devices that includes the at least one mote device. For example, the mote device 11 can be located within the mote network, such that mote device is not achieving its portion of the error goal for the set of mote devices within the mote network. One embodiment of the identifying, at least partially using a maintaining device, at least one mote device to be maintained based at least in part on determining that the at least one mote device is not operating properly of operation 2002 can include operation 2046, that can include, but is not limited to, identifying the at least one mote device to be maintained at least partially based on a person marking the at least one mote device to be maintained. For example, the mote device can be marked by a person for maintaining by the maintaining device, such that the color, light emitted by, reflectivity, or other characteristics of the mote device can be varied. One embodiment of the identifying, at least partially using a maintaining device, at least one mote device to be maintained based at least in part on determining that the at least one mote device is not operating properly of operation 2002 can include operation 2048, that can include, but is not limited to, maintaining at least partially using the maintaining device of the at least one mote device. For example, as described with respect to FIG. 11, the maintaining device 50 maintains the mote device 11. One embodiment of the identifying, at least partially using a maintaining device, at least one mote device to be maintained based at least in part on determining that the at least one mote device is not operating properly of operation 2002 can include operation 2050, that can include, but is not limited to, destroying at least partially using the maintaining device of the at least one mote device in situ. For example, as described with respect to FIG. 11, the maintaining device 50 destroys the mote device 11. One embodiment of the identifying, at least partially using a maintaining device, at least one mote device to be maintained based at least in part on determining that the at least one mote device is not operating properly of operation 2002 can include operation 2052, that can include, but is not limited to, mechanically maintaining at least partially using the maintaining device the at least one mote device. For example, the maintaining device 50 mechanically maintains the mote device 11. One embodiment of the identifying, at least partially using a maintaining device, at least one mote device to be maintained based at least in part on determining that the at least one mote device is not operating properly of operation 2002 can include operation 2054, that can include, but is not limited to, automatically maintaining at least partially using the maintaining device the at least one mote device. For example, the maintaining device 50 automatically maintains the mote device using automated mote maintaining and/or mote locating techniques. One embodiment of the identifying, at least partially using a maintaining device, at least one mote device to be maintained based at least in part on determining that the at least one mote device is not operating properly of operation 2002 can include operation 2056, that can include, but is not limited to, identifying the at least one mote device to be maintained based at least in part on an outward appearance of the at least one mote device. For example, the maintaining device 50 identifies the mote device to be maintained based on an outward appearance, such as a color, shape, reflectivity, etc. of the mote device. One embodiment of the identifying, at least partially using a maintaining device, at least one mote device to be maintained based at least in part on determining that the at least one mote device is not operating properly of operation 2002 can include operation 2057, that can include, but is not limited to, identifying the at least one mote device to be maintained based at least in part on a sensed condition of the at least one mote device. For example, the maintaining device 50 identifies a sensed condition of the mote device, such as a color, shape, etc. One embodiment of the identifying, at least partially using a maintaining device, at least one mote device to be maintained based at least in part on determining that the at least one mote device is not operating properly of operation 2002 can include operation 2058, that can include, but is not limited to, identifying the at least one mote device to be maintained based at least in part on a sensed error condition of the at least one mote device. For example, the maintaining device identifies at least one mote device based at least partially on an error. One embodiment of the identifying, at least partially using a maintaining device, at least one mote device to be maintained based at least in part on determining that the at least one mote device is not operating properly of operation 2002 can include operation 2060, that can include, but is not limited to, identifying the at least one mote device to be maintained based at least in part on a sensed diagnostic condition of the at least one mote device. For example, the maintaining device identifies the at least one mote device based at least in part on the sensed diagnostic condition, such as a memory state, power state, etc. One embodiment of the identifying, at least partially using a maintaining device, at least one mote device to be maintained based at least in part on determining that the at least one mote device is not operating properly of operation 2002 can include operation 2062, that can include, but is not limited to, identifying the at least one mote device to be maintained based at least in part on a sensed insufficient device power of the at least one mote device. For example, the maintaining device identifies the mote device based at least in part on an insufficient device power as sensed by the maintaining device. One embodiment of the identifying, at least partially using a maintaining device, at least one mote device to be maintained based at least in part on determining that the at least one mote device is not operating properly of operation 2002 can include operation 2064, that can include, but is not limited to, identifying a last known location of the at least one mote device to be maintained determined at least in part on an input from at least one other mote device. For example, the maintaining device identifies the mote device based at least in part on an identified last known location, such as a geographic position. One embodiment of the identifying, at least partially using a maintaining device, at least one mote device to be maintained based at least in part on determining that the at least one mote device is not operating properly of operation 2002 can include operation 2068, that can include, but is not limited to, identifying the at least one mote device to be maintained based at least in part on a sensed insufficient processing power of the at least one mote device. For example, the maintaining device identifies the mote device based at least in part on a sensed insufficient processing power of the mote device. One embodiment of the identifying, at least partially using a maintaining device, at least one mote device to be maintained based at least in part on determining that the at least one mote device is not operating properly of operation 2002 can include operation 2070, that can include, but is not limited to, identifying the at least one mote device to be maintained based at least in part on a sensed insufficient battery power of the at least one mote device. For example, the maintaining device identifies the mote device based at least in part on a sensed insufficient power of at least one battery contained in the mote device. One embodiment of operation 2004 can include, but is not limited to, configuring at least one status indicator that can be at least partially used during the identifying of the at least one mote device to be maintained. One embodiment of operation 2006 can include, but is not limited to, configuring a color of the at least one mote device to at least partially identify the at least one mote device to be maintained. For example, the at least one mote device changes colors. One embodiment of operation 2008 can include, but is not limited to, configuring a reflectivity of the at least one mote device to at least partially identify the at least one mote device to be maintained. For example, the at least one mote device changes its surface reflectivity, such as by being oriented in a different direction. One embodiment of operation 2010 can include, but is not limited to, configuring a shape, position, or conformity of the at least one mote device to identify the at least one mote device to be maintained. For example, the shape, position, or conformity of the mote device is changed. One embodiment of operation 2012 can include, but is not limited to, configuring a portion of the at least one mote device that is exposed to at least partially identify the at least one mote device to be maintained. For example, at least a portion of the mote device that is exposed is reconfigured. One embodiment of operation 2014 can include, but is not limited to, configuring an auditory output from the at least one mote device to at least partially identify the at least one mote device to be maintained. For example, auditory output, such as a sound, voice, or other recording, is provided by those mote device(s) to be maintained. One embodiment of operation 2016 can include, but is not limited to, configuring a vibrational output from the at least one mote device to at least partially identify the at least one mote device to be maintained. For example, those mote devices that are to be maintained vibrate. One embodiment of operation 2018 can include, but is not limited to, configuring at least one status indicator that can be at least partially used during the identifying the at least one mote device, either on contact or in a medium, to be maintained. For example, some aspect of the mote device that can be sensed on contact, such as by touch, is changed in those mote devices to be maintained. One embodiment of operation 2020 can include, but is not limited to, configuring at least one fluorescent status indicator that can be at least partially used during the identifying the at least one mote device to be maintained. For example, configuring at least one of the fluorescent status indicators in the mote device(s) is to be maintained. One embodiment of operation 2022 can include, but is not limited to, configuring at least one status indicator that can be at least partially identify the at least one mote device to be maintained based at least partially on a contact. For example, changing a touch, feel, etc. of those mote device(s) to be maintained. One embodiment of operation 2024 can include, but is not limited to, configuring at least one status indicators that can be at least partially identify the at least one mote device to be maintained based at least partially on a presence of the at least one status indicators in a media. For example, maintaining those mote devices having status indicators in a particular media. One embodiment of operation 2026 can include, but is not limited to, repairing the at least one mote device at least partially in response to the identifying the at least one mote device to be maintained. For example, repairing at least one of the mote device(s) to be maintained. One embodiment of operation 2028 can include, but is not limited to, repairing the at least one mote device at least partially in response to a nature of the identifying the at least one mote device to be maintained. For example, repairing a mote device based on a nature of identifying the mote device, such as by identifying certain broken mote device(s), based on their color. As such, mote devices can change to a distinct color, emit distinct vibration characteristics, send a distinct signal, etc. based at least in part on the particular reason for maintaining of the mote device. The order of the operations, methods, mechanisms, etc. as described with respect to FIGS. 12a to 12c are intended to be illustrative in nature, and not limited in scope.

One embodiment of the interaction between the mote device and the maintaining device is described with respect to FIG. 11, in which the maintaining device identifies at least one mote device that is operating improperly, and is to be maintained as described in this disclosure. Examples of reasons why the mote device may be operating improperly include, but are not limited to, insufficient mote device power or energy, insufficient battery power or energy for the mote device, improper data storage, etc. as described in this disclosure.

Another embodiment of a mote maintaining mechanism is described with respect to FIG. 13, in which the maintaining device determines that it is time to maintain at least one mote device that has been operating properly. Consider, for example, a mote device has been maintaining data relating to sensed parameters for a sufficient duration to justify maintaining of that data contained in the mote device. If the mote device has been sensing data for several months, and that data represents a typical duration for obtaining data for a typical lifetime of the mote, then the maintaining device can be configured to maintain the mote device based on routine maintenance by the maintenance device, and thereupon the mote information can be downloaded or otherwise accessed. Under these circumstances, the maintaining device can consider such aspects of mote device data collection as duration of continued data collection, frequency of data collection, a moderate data retrieved during each sampling period of data collection, etc. The maintaining techniques, as described herein, can thereby be utilized to identify those mote devices to be maintained, and in certain embodiments, maintain the at least one mote device. In certain embodiments, once the maintaining device has maintained the mote device, then the maintaining device can download the data and in other embodiments, transfer the data to another device for analysis and/or processing.

It is envisioned that some combination of the reasons for maintaining mote devices, such as described with respect to FIGS. 11, 13, etc. may be utilized. For example, the maintaining device can consider a lightly-utilized network, and identify those mote devices to be collected to be reconfigured and perhaps transferred to another mote network or discarded. In another embodiment, a mote device that is operating properly now may be collected if it is determined that it is likely to run out of power soon. There are thus a variety of reasons why mote devices within mote networks are to be collected, and it is envisioned that the functions and operations of maintenance devices within the mote networks are also envisioned to provide for the flexibility of the mote networks.

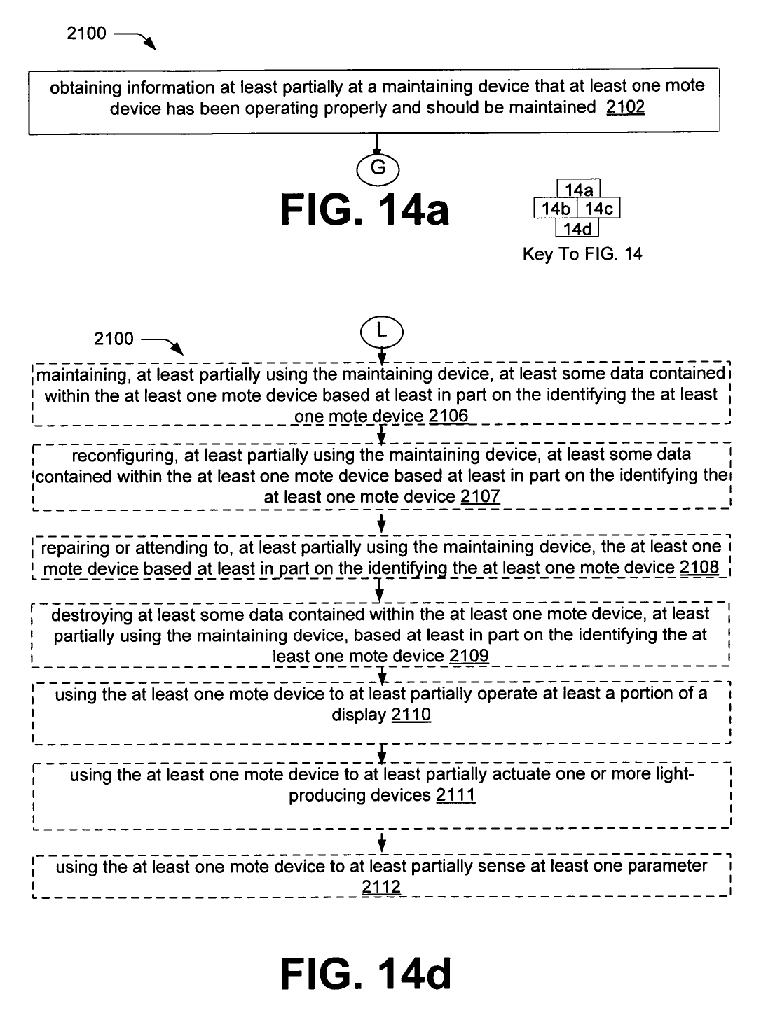

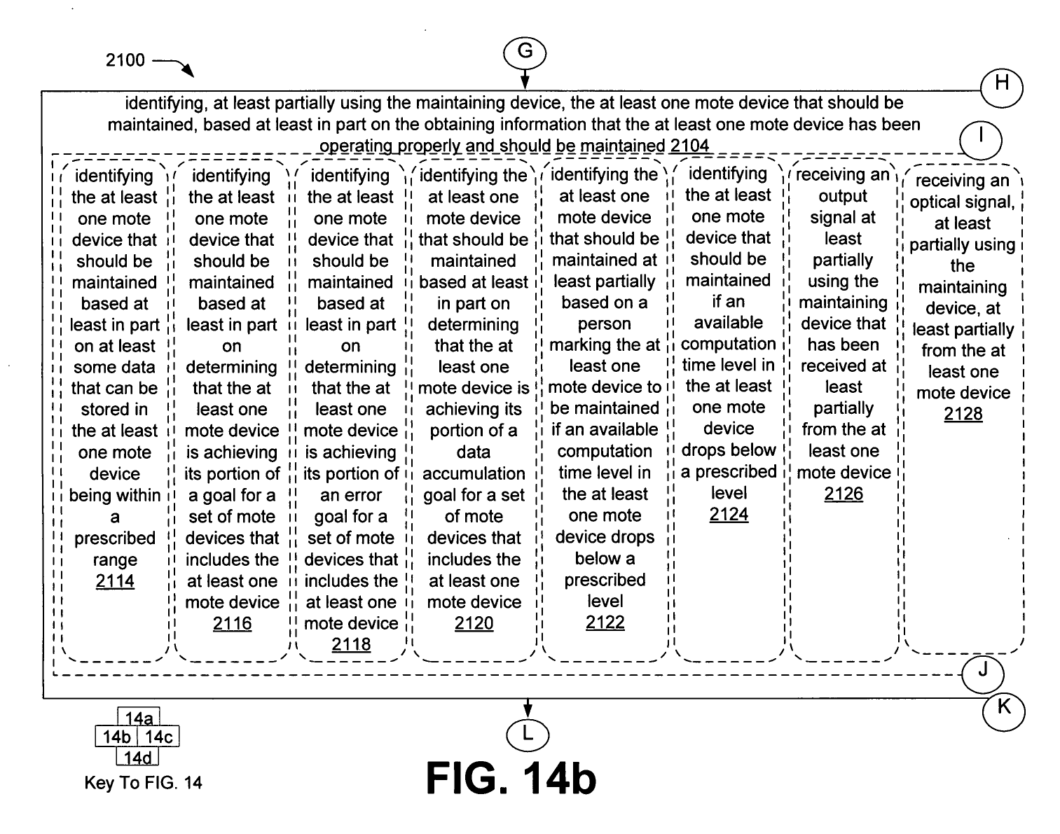

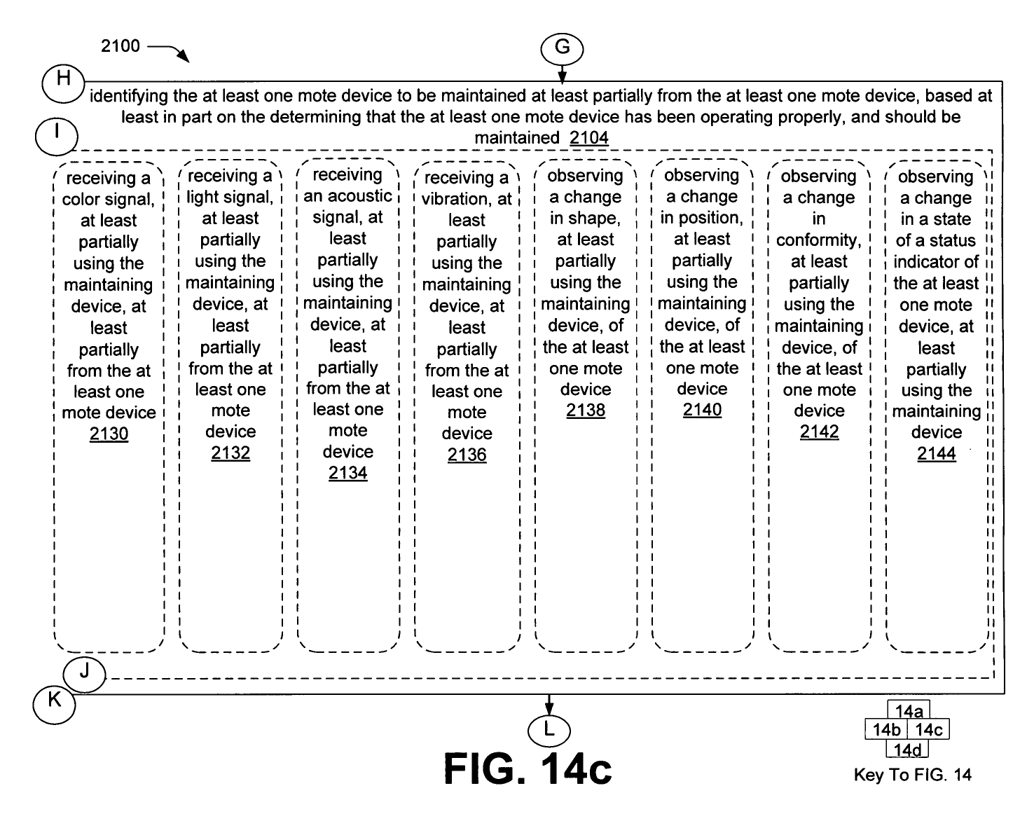

One embodiment of a high-level flowchart of a processing and/or sharing technique 2100 that is described with respect to FIG. 14 (which includes FIGS. 14a, 14b, 14c, and 14d) and which includes, but is not limited to, operations 2102 and 2104, as well as optional operation 2106, 2107, 2108, 2109, 2110, 2111, and/or 2112. Operation 2104 can include, but is not limited to, optional operations 2114, 2116, 2118, 2120, 2122, 2124, 2126, 2128, 2130, 2132, 2134, 2136, 2138, 2140, 2142, and/or 2144. The high-level flowchart of FIG. 14 should be considered in combination with the mote device 11, as described with respect to FIG. 13. One embodiment of operation 2102 can include, but is not limited to, obtaining information at least partially at a maintaining device that at least one mote device has been operating properly and should be maintained. For example, obtaining information that can indicate that a particular mote device has been operating properly (for example, for a sufficient time period or at a sufficient energy or power level), but that it likely requires maintenance, such as routine or expected maintenance as might be expected. One embodiment of operation 2104 can include, but is not limited to, identifying, at least partially using the maintaining device, the at least one mote device that should be maintained, based at least in part on the obtaining information that the at least one mote device has been operating properly and should be maintained. For example, identifying certain mote device(s) that should be maintained based on them likely requiring routine or expected maintenance. The identifying, at least partially using the maintaining device, the at least one mote device that should be maintained, based at least in part on the obtaining information that the at least one mote device has been operating properly and should be maintained of operation 2104 can include operation 2114, that can include, but is not limited to, identifying the at least one mote device that should be maintained based at least in part on at least some data that can be stored in the at least one mote device being within a prescribed range. For example, identifying certain mote devices that can store below a prescribed amount of data as those that should be maintained. The identifying, at least partially using the maintaining device, the at least one mote device that should be maintained, based at least in part on the obtaining information that the at least one mote device has been operating properly and should be maintained of operation 2104 can include operation 2116, that can include, but is not limited to, identifying the at least one mote device that should be maintained based at least in part on determining that the at least one mote device is achieving its portion of a goal for a set of mote devices that includes the at least one mote device. For example, determining the mote device should be maintained based on its ability to perform its portion of a goal for multiple mote devices (e.g., that can be formed in a mote network). The identifying, at least partially using the maintaining device, the at least one mote device that should be maintained, based at least in part on the obtaining information that the at least one mote device has been operating properly and should be maintained of operation 2104 can include operation 2118, that can include, but is not limited to, identifying the at least one mote device that should be maintained based at least in part on determining that the at least one mote device is achieving its portion of an error goal for a set of mote devices that includes the at least one mote device. For example, determining that a mote device should be maintained based upon it operating without errors for some prescribed duration. The identifying, at least partially using the maintaining device, the at least one mote device that should be maintained, based at least in part on the obtaining information that the at least one mote device has been operating properly and should be maintained of operation 2104 can include operation 2120, that can include, but is not limited to, identifying the at least one mote device that should be maintained based at least in part on determining that the at least one mote device is achieving its portion of a data accumulation goal for a set of mote devices that includes the at least one mote device. For example, identifying a mote device to be maintained based on its achieving a particular data accumulation goal (e.g., data stored within a mote device for a prescribed duration). The identifying, at least partially using the maintaining device, the at least one mote device that should be maintained, based at least in part on the obtaining information that the at least one mote device has been operating properly and should be maintained of operation 2104 can include operation 2122, that can include, but is not limited to, identifying the at least one mote device that should be maintained at least partially based on a person marking the at least one mote device to be maintained if an available computation time level in the at least one mote device drops below a prescribed level. For example, identifying the mote to be maintained at least partially based on a person marking the mote device (e.g., with the markers the changes a call or, texture, reflectivity, etc. of at least a portion of the mote device). The identifying, at least partially using the maintaining device, the at least one mote device that should be maintained, based at least in part on the obtaining information that the at least one mote device has been operating properly and should be maintained of operation 2104 can include operation 2124, that can include, but is not limited to, identifying the at least one mote device that should be maintained if an available computation time level in the at least one mote device drops below a prescribed level. For example, identifying a mote device be maintained if it's available computation time drops below a prescribed level. The identifying, at least partially using the maintaining device, the at least one mote device that should be maintained, based at least in part on the obtaining information that the at least one mote device has been operating properly and should be maintained of operation 2104 can include operation 2126, that can include, but is not limited to, receiving an output signal at least partially using the maintaining device that has been received at least partially from the at least one mote device For example, the maintaining device receiving the output signal. The identifying, at least partially using the maintaining device, the at least one mote device that should be maintained, based at least in part on the obtaining information that the at least one mote device has been operating properly and should be maintained of operation 2104 can include operation 2128, that can include, but is not limited to, receiving an optical signal, at least partially using the maintaining device, at least partially from the at least one mote device. For example, the maintaining device identifies the mote device to be maintained at least partially by receiving the optical signal. The identifying, at least partially using the maintaining device, the at least one mote device that should be maintained, based at least in part on the obtaining information that the at least one mote device has been operating properly and should be maintained of operation 2104 can include operation 2130, that can include, but is not limited to, receiving a color signal, at least partially using the maintaining device, at least partially from the at least one mote device. For example, the maintaining device identifies the mote device that could be maintained at least partially by receiving the color signal. The identifying, at least partially using the maintaining device, the at least one mote device that should be maintained, based at least in part on the obtaining information that the at least one mote device has been operating properly and should be maintained of operation 2104 can include operation 2132, that can include, but is not limited to, receiving a light signal, at least partially using the maintaining device, at least partially from the at least one mote device. For example, the maintaining device identifies the mote device that could be maintained at least partially by receiving the light signal. The identifying, at least partially using the maintaining device, the at least one mote device that should be maintained, based at least in part on the obtaining information that the at least one mote device has been operating properly and should be maintained of operation 2104 can include operation 2134, that can include, but is not limited to, receiving an acoustic signal, at least partially using the maintaining device, at least partially from the at least one mote device. For example, the maintaining device identifies the mote device that could be maintained at least partially by receiving the acoustic signal. The identifying, at least partially using the maintaining device, the at least one mote device that should be maintained, based at least in part on the obtaining information that the at least one mote device has been operating properly and should be maintained of operation 2104 can include operation 2136, that can include, but is not limited to, receiving a vibration, at least partially using the maintaining device, at least partially from the at least one mote device. For example, the maintaining device receives the vibration. The identifying, at least partially using the maintaining device, the at least one mote device that should be maintained, based at least in part on the obtaining information that the at least one mote device has been operating properly and should be maintained of operation 2104 can include operation 2138, that can include, but is not limited to, observing a change in shape, at least partially using the maintaining device, of the at least one mote device. For example, the maintaining device observes a change in shape of the mote device. The identifying, at least partially using the maintaining device, the at least one mote device that should be maintained, based at least in part on the obtaining information that the at least one mote device has been operating properly and should be maintained of operation 2104 can include operation 2140, that can include, but is not limited to, observing a change in position, at least partially using the maintaining device, of the at least one mote device. For example, the maintaining device observes a change in position of the mote device. The identifying, at least partially using the maintaining device, the at least one mote device that should be maintained, based at least in part on the obtaining information that the at least one mote device has been operating properly and should be maintained of operation 2104 can include operation 2142, that can include, but is not limited to, observing a change in conformity, at least partially using the maintaining device, of the at least one mote device. For example, the maintaining device observing the change in conformity of the mote device. The identifying, at least partially using the maintaining device, the at least one mote device that should be maintained, based at least in part on the obtaining information that the at least one mote device has been operating properly and should be maintained of operation 2104 can include operation 2144, that can include, but is not limited to, observing a change in a state of a status indicator of the at least one mote device, at least partially using the maintaining device. For example, the maintaining device observing the change in state of the status indicator. One embodiment of optional operation 2106 can include, but is not limited to, maintaining, at least partially using the maintaining device, at least some data contained within the at least one mote device based at least in part on the identifying the at least one mote device. For example, the maintaining device maintaining the mote device. One embodiment of optional operation 2107 can include, but is not limited to, reconfiguring, at least partially using the maintaining device, at least some data contained within the at least one mote device based at least in part on the identifying the at least one mote device. For example, the maintaining device reconfiguring the mote device. One embodiment of optional operation 2108 can include, but is not limited to, repairing or attending to, at least partially using the maintaining device, the at least one mote device based at least in part on the identifying the at least one mote device. For example, the maintaining device repairing or attending to the mote device. One embodiment of optional operation 2109 can include, but is not limited to, destroying at least some data contained within the at least one mote device, at least partially using the maintaining device, based at least in part on the identifying the at least one mote device. For example, the maintaining device destroying the mote device. One embodiment of optional operation 2110 can include, but is not limited to, using the at least one mote device to at least partially operate at least a portion of a display. For example, the mote device operates a portion of a display. One embodiment of optional operation 2111 can include, but is not limited to, using the at least one mote device to at least partially actuate one or more light-producing devices. For example, using the mote device to actuate a portion of a light device. One embodiment of optional operation 2112 can include, but is not limited to, using the at least one mote device to at least partially sense at least one parameter. For example, sensing a parameter with a mote device. The order of the operations, methods, mechanisms, etc. as described with respect to FIGS. 13 or 14 (including FIGS. 14a, 14b, 14c, and 14d) are intended to be illustrative in nature, and not limited in scope.

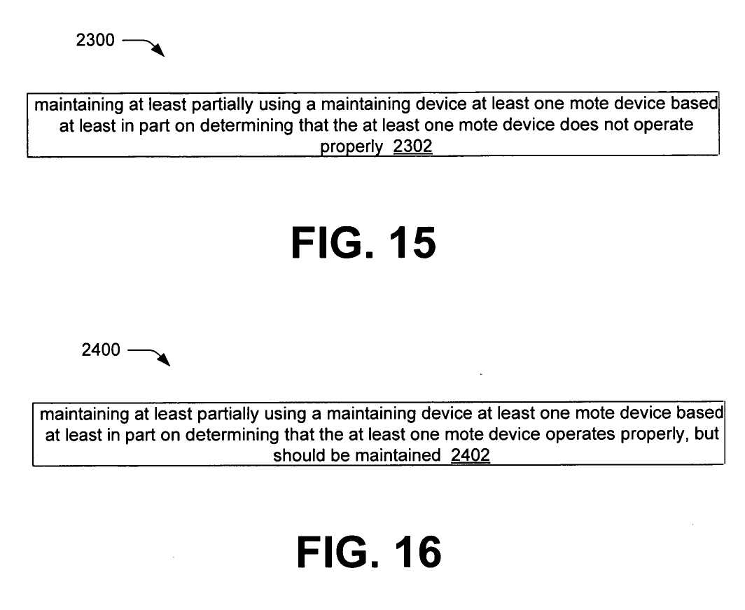

One embodiment of a high-level flowchart of a mote maintaining technique 2300 that is described with respect to FIG. 15 and which includes, but is not limited to, operation 2302. One embodiment of operation 2302 can include, but is not limited to, maintaining at least partially using a maintaining device at least one mote device based at least in part on determining that the at least one mote device operates properly, but should be maintained. For example, the maintaining device 50, as described with respect to FIG. 13, maintains the mote device upon determination that the mote device is not operating properly according to some criteria determined by the maintenance device. The order of the operations, methods, mechanisms, etc. as described with respect to FIG. 15 are intended to be illustrative in nature, and not limited in scope.

One embodiment of a high-level flowchart of a mote maintaining technique 2300 that is described with respect to FIG. 16 and which includes, but is not limited to, operation 2402. One embodiment of operation 2402 can include, but is not limited to, maintaining at least partially using a maintaining device at least one mote device based at least in part on determining that the at least one mote device operates properly, but should be maintained. For example, the maintaining device 50, as described with respect to FIG. 13, maintains the mote device upon determination that the mote device is operating properly according to some criteria determined by the maintenance device, but should be maintained based on routine maintenance, etc. The order of the operations, methods, mechanisms, etc. as described with respect to FIG. 16 are intended to be illustrative in nature, and not limited in scope.

In one or more various aspects, related systems include but are not limited to circuitry and/or programming for effecting the herein-referenced method aspects; the circuitry and/or programming can be virtually any combination of hardware, software, electromechanical system, and/or firmware configurable to effect the herein- referenced method aspects depending upon the design choices of the system designer.

VII. Conclusion

This disclosure provides a number of embodiments of mote networks that can include one or more mote devices, each mote device can allow sensed data or information that is located at the one mote device to be transferred to another mote device or another device. The embodiments of the mote devices as described with respect to this disclosure are intended to be illustrative in nature, and are not limiting its scope.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle can vary with the context in which the processes and/or systems and/or other technologies are deployed. For example, if an implementer determines that speed and accuracy are paramount, the implementer may opt for mainly a hardware and/or firmware vehicle; alternatively, if flexibility is paramount, the implementer may opt for mainly a software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle can be deployed and the specific concerns (e.g., speed, flexibility, or predictability) of the implementer, any of which may vary.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, “operably linked”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

It is to be understood by those skilled in the art that, in general, that the terms used in the disclosure, including the drawings and the appended claims (and especially as used in the bodies of the appended claims), are generally intended as “open” terms. For example, the term “including” should be interpreted as “including but not limited to”; the term “having” should be interpreted as “having at least”; and the term “includes” should be interpreted as “includes, but is not limited to”; etc. In this disclosure and the appended claims, the terms “a”, “the”, and “at least one” located prior to one or more items are intended to apply inclusively to either one or a plurality of those items.

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that could have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that could have A alone, B alone, C alone, A and B together, A and C together, B and C together, and/or A, B, and C together, etc.).

Those skilled in the art will appreciate that the herein-described specific exemplary processes and/or devices and/or technologies are representative of more general processes and/or devices and/or technologies taught elsewhere herein, such as in the claims filed herewith and/or elsewhere in the present application.

Within this disclosure, elements that perform similar functions in a similar way in different embodiments may be provided with the same or similar numerical reference characters in the figures.

1. A method, comprising:
identifying, at least partially using a maintaining device, at least one mote device to be maintained based at least in part on determining that the at least one mote device is not operating properly.

2. The method of claim 1, wherein the identifying, at least partially using a maintaining device, at least one mote device to be maintained based at least in part on determining that the at least one mote device is not operating properly further comprises:
identifying the at least one mote device to be maintained based at least in part on the determining that the at least one mote device is not achieving its portion of a goal for a set of mote devices that includes the at least one mote device.

3. The method of claim 1, wherein the identifying, at least partially using a maintaining device, at least one mote device to be maintained based at least in part on determining that the at least one mote device is not operating properly further comprises:
identifying the at least one mote device to be maintained based at least in part on the determining that the at least one mote device is not achieving its portion of a data accumulation goal for a set of mote devices that includes the at least one mote device.

4. The method of claim 1, wherein the identifying, at least partially using a maintaining device, at least one mote device to be maintained based at least in part on determining that the at least one mote device is not operating properly further comprises:
identifying the at least one mote device to be maintained based at least in part on the determining that the at least one mote device is not achieving its portion of an error goal for a set of mote devices that includes the at least one mote device.

5. The method of claim 1, wherein the identifying, at least partially using a maintaining device, at least one mote device to be maintained based at least in part on determining that the at least one mote device is not operating properly further comprises:
identifying the at least one mote device to be maintained at least partially based on a person marking the at least one mote device to be maintained.

6. (cancled)

7. The method of claim 1, wherein the identifying, at least partially using a maintaining device, at least one mote device to be maintained based at least in part on determining that the at least one mote device is not operating properly further comprises:
destroying, at least partially using the maintaining device, the at least one mote device in situ.

8. The method of claim 1, wherein the identifying, at least partially using a maintaining device, at least one mote device to be maintained based at least in part on determining that the at least one mote device is not operating properly further comprises:
mechanically maintaining, at least partially using the maintaining device, the at least one mote device.

9. (canceled)

10. The method of claim 1, wherein the identifying, at least partially using a maintaining device, at least one mote device to be maintained based at least in part on determining that the at least one mote device is not operating properly further comprises:
identifying the at least one mote device to be maintained based at least in part on an outward appearance of the at least one mote device.

11. The method of claim 1, wherein the identifying, at least partially using a maintaining device, at least one mote device to be maintained based at least in part on determining that the at least one mote device is not operating properly further comprises:
identifying the at least one mote device to be maintained based at least in part on a sensed condition of the at least one mote device.

12. The method of claim 1, wherein the identifying, at least partially using a maintaining device, at least one mote device to be maintained based at least in part on determining that the at least one mote device is not operating properly further comprises:
identifying the at least one mote device to be maintained based at least in part on a sensed error condition of the at least one mote device.

13. The method of claim 1, wherein the identifying, at least partially using a maintaining device, at least one mote device to be maintained based at least in part on determining that the at least one mote device is not operating properly further comprises:
identifying the at least one mote device to be maintained based at least in part on a sensed diagnostic condition of the at least one mote device.

14. (canceled)

15. The method of claim 1, wherein the identifying, at least partially using a maintaining device, at least one mote device to be maintained based at least in part on determining that the at least one mote device is not operating properly further comprises:
identifying a last known location of the at least one mote device to be maintained determined at least in part on an input from at least one other mote device.

16. (canceled)

17. The method of claim 1, wherein the identifying, at least partially using a maintaining device, at least one mote device to be maintained based at least in part on determining that the at least one mote device is not operating properly further comprises:
identifying the at least one mote device to be maintained based at least in part on a sensed insufficient battery power of the at least one mote device.

18. (canceled)

19. The method of claim 1, further comprising:
configuring a color of the at least one mote device to at least partially identify the at least one mote device to be maintained.

20. (canceled)

21. The method of claim 1, further comprising:
configuring a shape, position, or conformity of the at least one mote device to identify the at least one mote device to be maintained.

22. (canceled)

23. The method of claim 1, further comprising:
configuring an auditory output from the at least one mote device to at least partially identify the at least one mote device to be maintained.

24. The method of claim 1, further comprising:
configuring a vibrational output from the at least one mote device to at least partially identify the at least one mote device to be maintained.

25. The method of claim 1, further comprising:
configuring at least one status indicator that can be at least partially used during the identifying the at least one mote device, either on contact or in a medium, to be maintained.

26. (canceled)

27. (canceled)

28. (canceled)

29. The method of claim 1, further comprising:
repairing the at least one mote device at least partially in response to the identifying the at least one mote device to be maintained.

30. (canceled)

31. The method of claim 1, further comprising
using the at least one mote device to at least partially operate at least a portion of a display.

32. (canceled)

33. (canceled)

34. A method, comprising:
obtaining information, at least partially at a maintaining device, that at least one mote device has been operating properly and should be maintained; and
identifying, at least partially using the maintaining device, the at least one mote device that should be maintained, based at least in part on the obtaining information that the at least one mote device has been operating properly and should be maintained.

35. (canceled)

36. The method of claim 34, wherein the identifying, at least partially using the maintaining device, the at least one mote device that should be maintained, based at least in part on the obtaining information that the at least one mote device has been operating properly and should be maintained comprises:
identifying the at least one mote device that should be maintained based at least in part on determining that the at least one mote device is achieving its portion of a goal for a set of mote devices that includes the at least one mote device.

37. The method of claim 34, wherein the identifying, at least partially using the maintaining device, the at least one mote device that should be maintained, based at least in part on the obtaining information that the at least one mote device has been operating properly and should be maintained comprises:
identifying the at least one mote device that should be maintained based at least in part on determining that the at least one mote device is achieving its portion of an error goal for a set of mote devices that includes the at least one mote device.

38. The method of claim 34, wherein the identifying, at least partially using the maintaining device, the at least one mote device that should be maintained, based at least in part on the obtaining information that the at least one mote device has been operating properly and should be maintained comprises:
identifying the at least one mote device that should be maintained based at least in part on determining that the at least one mote device is achieving its portion of a data accumulation goal for a set of mote devices that includes the at least one mote device.

39. (canceled)

40. The method of claim 34, wherein the identifying, at least partially using the maintaining device, the at least one mote device that should be maintained, based at least in part on the obtaining information that the at least one mote device has been operating properly and should be maintained comprises:
identifying the at least one mote device that should be maintained if an available computation time level in the at least one mote device drops below a prescribed level.

41. (canceled)

42. The method of claim 34, wherein the identifying, at least partially using the maintaining device, the at least one mote device that should be maintained, based at least in part on the obtaining information that the at least one mote device has been operating properly and should be maintained comprises:
receiving an optical signal, at least partially using the maintaining device, at least partially from the at least one mote device.

43. The method of claim 34, wherein the identifying, at least partially using the maintaining device, the at least one mote device that should be maintained, based at least in part on the obtaining information that the at least one mote device has been operating properly and should be maintained comprises:
receiving a color signal, at least partially using the maintaining device, at least partially from the at least one mote device.

44. (canceled)

45. (canceled)

46. The method of claim 34, wherein the identifying, at least partially using the maintaining device, the at least one mote device that should be maintained, based at least in part on the obtaining information that the at least one mote device has been operating properly and should be maintained comprises:
receiving a vibration, at least partially using the maintaining device, at least partially from the at least one mote device.

47. (canceled)

48. The method of claim 34, wherein the identifying, at least partially using the maintaining device, the at least one mote device that should be maintained, based at least in part on the obtaining information that the at least one mote device has been operating properly and should be maintained comprises:
observing a change in position, at least partially using the maintaining device, of the at least one mote device.

49. The method of claim 34, wherein the identifying, at least partially using the maintaining device, the at least one mote device that should be maintained, based at least in part on the obtaining information that the at least one mote device has been operating properly and should be maintained comprises:
observing a change in conformity, at least partially using the maintaining device, of the at least one mote device.

50. (canceled)

51. The method of claim 34, further comprising
maintaining, at least partially using the maintaining device, at least some data contained within the at least one mote device based at least in part on the identifying the at least one mote device.

52. (canceled)

53. (canceled)

54. The method of claim 34, further comprising
destroying at least some data contained within the at least one mote device, at least partially using the maintaining device, based at least in part on the identifying the at least one mote device.

55. (canceled)

56. The method of claim 34, further comprising
using the at least one mote device to at least partially actuate one or more light-producing devices.

57. (canceled)

58. A method, comprising:
maintaining, at least partially using a maintaining device, at least one mote device based at least in part on determining that the at least one mote device does not operate properly.

59. A method, comprising:
maintaining, at least partially using a maintaining device, at least one mote device based at least in part on determining that the at least one mote device operates properly, but should be maintained.

60. An apparatus, comprising:
a maintaining device to aid in determining, at least partially using a status indicator to determine, whether an at least one mote device should be maintained.

61. (canceled)

62. An apparatus, comprising:
a maintaining device operable to identify at least one mote device to be maintained at least partially in response to the maintaining device obtaining information that the at least one mote device is not operating properly.

63. (canceled)

64. The apparatus of claim 62, wherein the maintaining device operable to identify at least one mote device to be maintained at least partially in response to the maintaining device obtaining information that the at least one mote device is not operating properly further comprises:
the maintaining device operable to identify the at least one mote device to maintain based at least in part on a sensed condition of the at least one mote device.

65. The apparatus of claim 62, wherein the maintaining device operable to identify at least one mote device to be maintained at least partially in response to the maintaining device obtaining information that the at least one mote device is not operating properly further comprises:
the maintaining device operable to identify the at least one mote device to maintain based at least in part on a sensed insufficient device power of the at least one mote device.

66. (canceled)

67. The apparatus of claim 62, wherein the maintaining device operable to identify at least one mote device to be maintained at least partially in response to the maintaining device obtaining information that the at least one mote device is not operating properly further comprises:
the maintaining device operable to identify the at least one mote device to maintain based at least in part on a sensed insufficient battery power of the at least one mote device.

68. The apparatus of claim 62, wherein the maintaining device operable to identify at least one mote device to be maintained at least partially in response to the maintaining device obtaining information that the at least one mote device is not operating properly further comprises:
the maintaining device operable to receive input from at least one status indicator that is operable to be configured by the at least one mote device.

69. (canceled)

70. (canceled)

71. (canceled)

72. The apparatus of claim 62, further comprising:
the maintaining device operable to at least partially maintain the at least one mote device.

73. (canceled)

74. (canceled)

75. The apparatus of claim 62, further comprising:
the maintaining device operable to at least partially repair the at least one mote device.

76. (canceled)

77. An apparatus, comprising:
a maintaining device operable to obtain information describing that at least one mote device has been operating properly and should be maintained; and
the maintaining device operable to identify the at least one mote device to maintain based at least in part on the maintaining device being operable to obtain the information.

78. (canceled)

79. (canceled)

80. The apparatus of claim 77, wherein the maintaining device operable to identify the at least one mote device to maintain comprises:
the maintaining device operable to identify the at least one mote device to maintain based at least in part on input from a person to at least partially determine that the at least one mote device has been operating properly.

81. The apparatus of claim 77, further comprising:
the maintaining device operable to maintain the at least one mote device at least partially in response to the maintaining device to identify the at least one mote device to maintain.

82. The apparatus of claim 77, further comprising:
the maintaining device operable to reconfigure at least some data contained within the at least one mote device.

83. (canceled)

84. (canceled)

85. An apparatus, comprising:
maintaining means for identifying at least one mote device to maintain based at least in part on determining that the at least one mote device is not operating properly.

86. An apparatus, comprising:
determining means for at least partially determining that at least one mote device has been operating properly; and
maintaining means for identifying the at least one mote device to maintain the at least one mote device based at least in part on the determining means determining that the at least one mote device has been operating properly.
